(19) United States
(12) Patent Application Publication
(10) Pub. No.: US 2018/0238099 A1
(43) Pub. Date: Aug. 23, 2018

(54) POWER SWING DOOR WITH VIRTUAL HANDLE GESTURE CONTROL

(71) Applicant: Magna Closures Inc., Newmarket (CA)

(72) Inventors: Kurt M. SCHATZ, Uxbridge (CA); Samuel R. BARUCO, Aurora (CA); J.R. Scott MITCHELL, Newmarket (CA); Marlon D.R. HILLA, Newmarket (CA); Wassim RAFRAFI, Newmarket (CA); Gabriele Wayne SABATINI, Keswick (CA)

(21) Appl. No.: 15/898,439

(22) Filed: Feb. 17, 2018

Related U.S. Application Data
(60) Provisional application No. 62/460,188, filed on Feb. 17, 2017.
(60) Provisional application No. 62/554,642, filed on Sep. 6, 2017.

(51) Int. Cl. E05F 15/74; G06F 3/01; E05F 15/611

(52) U.S. Cl. CPC E05F 15/74; G06F 3/017; E05F 2015/765; E05B 81/77; E05F 15/611

(57) ABSTRACT

A non-contact obstacle detection (NCOD) system and a virtual handle assembly for a motor vehicle and a method of operating the non-contact obstacle detection system and a closure member using a virtual handle assembly are disclosed. The NCOD system includes a main electronic control unit. At least one non-contact obstacle sensor is coupled to the main electronic control unit for detecting obstacles. The control unit is configured to detect the obstacle and cease opening of the closure member in response to the obstacle being detected. Additionally, the control unit is configured to release a latch and apply power to a motor in response to the obstacle not being detected. The virtual handle assembly includes at least one virtual handle sensor for detecting a hand and maintaining a distance to the hand by operating an actuation system to move the closure member.

### CROSS-REFERENCE TO RELATED APPLICATIONS

This utility application claims the benefit of U.S. Provisional Application No. 62/460,188 filed Feb. 17, 2017 and U.S. Provisional Application No. 62/554,642 filed Sep. 6, 2017. The entire disclosures of the above applications are incorporated herein by reference.

### FIELD

The present disclosure relates generally to a side door non-contact obstacle detection system and a power swing door with a virtual handle assembly capable of gesture control and methods of operating the non-contact obstacle detection system and the power swing door using the virtual handle assembly.

### BACKGROUND

This section provides background information related to the present disclosure which is not necessarily prior art.

Motor vehicles are increasingly being equipped with sensors that detect the environment and terrain surrounding the motor vehicle. For example, some vehicles include sensor systems that provide images of the terrain and/or other objects in the vicinity of the vehicle. Sensing systems utilizing radar have also been used to detect the presence and position of objects near the motor vehicle while the vehicle is moving. The signals and data generated by these sensor systems can be used by other systems of the motor vehicle to provide safety features such as vehicle control, collision avoidance, and parking assistance. Such sensing systems are generally used to assist the driver while he or she is driving the motor vehicle and/or to intervene in controlling the vehicle.

Additionally, closure members (e.g. doors, lift gates, etc.) are increasingly provided with powered actuation mechanisms capable of opening and/or closing the closure members. Typically, powered actuation systems, such as power door actuation systems include a power-operated device such as, for example, an electric motor and a rotary-to-linear conversion device that are operable for converting the rotary output of the electric motor into translational movement of an extensible member. In most arrangements, the electric motor and the conversion device are mounted to the passenger door and the distal end of the extensible member is fixedly secured to the vehicle body. One example of a power door actuation system is shown in commonly-owned U.S. Pat. No. 9,174,517 which discloses a power swing door actuator having a rotary-to-linear conversion device configured to include an externally-threaded leadscrew rotatively driven by the electric motor and an internally-threaded drive nut meshingly engaged with the leadscrew and to which the extensible member is attached. Accordingly, control over the speed and direction of rotation of the leadscrew results in control over the speed and direction of translational movement of the drive nut and the extensible member for controlling swinging movement of the passenger door between its open and closed positions. Such power actuated operation can lead to issues with the closure members unintentionally striking surrounding objects or obstacles. For example, an object near the closure member may obstruct the opening or closing of the closure member and/or the closure member may be damaged if opened under power and strikes the obstacle. However, known sensing system or obstacle detection systems do not properly address potential situations involving obstacles.

Thus, there is an increasing need for improved sensor assemblies and methods of operating closure members as well as obstacle detection systems that prevent the closure member from colliding with nearby objects primarily when the vehicle is stationary. Furthermore, other desirable features and characteristics of the present disclosure will become apparent from the subsequent detailed description and the appended claims, taken in conjunction with the accompanying drawings and the foregoing technical field and background.

### SUMMARY

This section provides a general summary of the present disclosure and is not intended to be interpreted as a comprehensive disclosure of its full scope or all of its features, aspects and objectives.

Accordingly, it is an aspect of the present disclosure to provide a virtual handle assembly. The virtual handle assembly includes a handle housing. At least one virtual handle sensor is disposed in the handle housing for detecting a hand in proximity to the virtual handle assembly. A sensor microcontroller is disposed in the handle housing and is coupled to the at least one virtual handle sensor and in communication with an actuation system coupled to a closure member. The sensor microcontroller is configured to detect one of a gesture and a hand being placed in proximity the at least one virtual handle sensor. Additionally, the sensor microcontroller is configured to command movement of the closure member by the actuation system in response to the detection one of a gesture and a hand being placed in proximity to the at least one virtual handle sensor.

According to another aspect of the disclosure, a method of moving a closure member using a virtual handle assembly is provided. The method begins by determining the position of the hand relative to the virtual handle assembly. Next, determining whether the hand is making a gesture in a gesture recognition mode state. The method continues by moving the closure member in response to determining that the hand is making a gesture. The next step of the method is determining whether the closure member moving triggers a non-contact obstacle detection (NCOD) system. The method concludes by transitioning back to the gesture recognition mode state in response to the NCOD system being triggered.

According to another aspect of the disclosure, a non-contact obstacle detection system for controlling movement of a closure member is provided. The non-contact obstacle detection system includes a main electronic control unit having a plurality of input-output terminals and adapted to connect to a power source. The non-contact obstacle detection system further includes at least one non-contact obstacle sensor coupled to the main electronic control unit for detecting obstacles near a closure member, each of the at least one non-contact obstacle sensor having a detection zone about the closure member and configured to be in one of an active mode and an inactive mode in response to the position of the closure member. The main electronic control unit is configured to detect if an obstacle is detected using the at least one non-contact obstacle sensor, cease movement of the closure member and disable the system in response to the obstacle being detected.

These and other aspects and areas of applicability will become apparent from the description provided herein. The description and specific examples in this summary are intended for purpose of illustration only and are not intended to limit the scope of the present disclosure.

### DRAWINGS

The drawings described herein are for illustrative purposes only of selected embodiments and not all implementations, and are not intended to limit the present disclosure to only that actually shown. With this in mind, various features and advantages of example embodiments of the present disclosure will become apparent from the following written description when considered in combination with the appended drawings, in which:

FIGS. 1 and 2 are block diagrams illustrating a non-contact obstacle detection system for a motor vehicle according to aspects of the disclosure;

FIG. 3 illustrates a block diagram of a sensor multiplexer hub of the non-contact obstacle detection system of FIGS. 1 and 2 according to an aspect of the disclosure;

FIGS. 4, 5A and 5B illustrate a lift gate proximity sensor of the non-contact obstacle detection system of FIGS. 1 and 2 on a lift gate of a vehicle according to an aspect of the disclosure;

FIG. 6 illustrates a block diagram of a lift gate module of the non-contact obstacle detection system of FIGS. 1 and 2 according to an aspect of the disclosure;

FIG. 7A-7D illustrates sensing capabilities of infrared sensors of the non-contact obstacle detection system of FIGS. 1 and 2 according to an aspect of the disclosure;

FIG. 8 illustrates a door handle sensor of the non-contact obstacle detection system of FIGS. 1 and 2 according to an aspect of the disclosure;

FIG. 9 illustrates a side view mirror sensor of the non-contact obstacle detection system of FIGS. 1 and 2 according to an aspect of the disclosure;

FIGS. 10A through 10D illustrate a housing assembly of an infrared sensor of the non-contact obstacle detection system of FIGS. 1 and 2 according to an aspect of the disclosure;

FIG. 11 illustrates steps of a method of teaching a plurality of lift gate modules according to an aspect of the disclosure;

FIG. 12 illustrates steps of a method of operating a lift gate having a plurality of lift gate modules according to an aspect of the disclosure;

FIG. 13 illustrates steps of a method of operating a front door having a side view mirror sensor according to an aspect of the disclosure;

FIG. 14 illustrates steps of a method of operating a rear door using a side view sensor according to an aspect of the disclosure;

FIG. 15 illustrates steps of a method of operating a side door having a door handle sensor according to an aspect of the disclosure;

FIG. 16 is a perspective view of an example motor vehicle equipped with a power door actuation system situated between a front passenger swing door and the vehicle body and which is constructed in accordance with the teachings of the present disclosure;

FIG. 17 is a diagrammatic view of the front passenger door shown in FIG. 16, with various components removed for clarity purposes only, in relation to a portion of the vehicle body and which is equipped with the power door actuation system of the present disclosure;

FIG. 18 is an isometric view of a power swing door actuator constructed according to the teachings of the present disclosure;

FIG. 19 is a view, similar to FIG. 18, with some components removed or shown transparently to better illustrate certain components of the power swing door actuator;

FIG. 20 is another view of the power swing door actuator of FIG. 18;

FIG. 21 illustrates composite views of the power swing door actuator of FIG. 18, as installed in a vehicle door and having an articulable linkage mechanism pivotally coupled to the vehicle body, for showing movement of the door between a fully-closed position, first and second intermediate positions, and a fully-open position;

FIG. 22 illustrates a virtual handle assembly according to aspects of the disclosure;

FIG. 23 illustrates an exploded view of the virtual handle assembly of FIG. 22 according to aspects of the disclosure;

FIGS. 24A-24C illustrate a driver microcontroller and accent LED printed circuit board of the virtual handle assembly of FIG. 22 according to aspects of the disclosure;

FIGS. 25A-25B illustrate a handle infrared sensor printed circuit board of the virtual handle assembly of FIG.22 according to aspects of the disclosure;

FIG. 26 illustrates an infrared photometric sensor of the handle infrared sensor printed circuit board of FIGS. 25A-25B according to aspects of the disclosure;

FIG. 27 illustrates a sensor microcontroller of the driver microcontroller and accent LED printed circuit board of FIG. 24A according to aspects of the disclosure;

FIG. 28 illustrates a graph of a received intensity over time of a channel of the infrared photometric sensor of FIG. 26 according to aspects of the disclosure;

FIGS. 29A-29C illustrates received position and intensity data received from the infrared photometric sensor of FIG. 26 and determination of a swipe via a gesture algorithm according to aspects of the disclosure;

FIG. 30A illustrates a door close gesture sequence according to aspects of the disclosure;

FIG. 30B illustrates a door open gesture sequence according to aspects of the disclosure;

FIG. 31 illustrates steps of a method of operating a power swing door using a virtual handle assembly of FIG. 22;

FIG. 32 illustrates steps of a method of operating the power swing door in a follow mode using the virtual handle assembly of FIG. 22;

FIGS. 33 and 34 illustrate other possible embodiments of gesture recognition using a virtual handle assembly similar to that shown FIG. 22 according to aspects of the disclosure;

FIG. 35 illustrates various positions of sensors of the non-contact obstacle detection on a vehicle, in accordance with an illustrative embodiment;

FIG. 36 is a top view of the side of a vehicle illustrating an area/volume of detection provided by the sensors of FIG. 35, in accordance with an illustrative embodiment;

FIGS. 37 and 38A-38C illustrate positions of a primary sensor in the outside mirror and a secondary sensor in the front door trim panel as part of the non-contact obstacle detection system on a vehicle, in accordance with an illustrative embodiment;

FIGS. 39 and 40A-40B illustrate positions of a primary sensor in the outside mirror and a secondary sensor in the rear door applique as part of the non-contact obstacle detection system on a vehicle, in accordance with an illustrative embodiment;

FIGS. 41 and 42A-42B illustrate positions of a primary sensor in the front door applique and a secondary sensor in the rear door applique as part of the non-contact obstacle detection system on a vehicle, in accordance with an illustrative embodiment;

FIGS. 43 and 44A-44B illustrate positions of a primary sensor in the outside mirror and a secondary sensor in the rear side rocker panel as part of the non-contact obstacle detection system on a vehicle, in accordance with an illustrative embodiment;

FIGS. 45 and 46A-46B illustrate positions of a primary sensor in the front door applique and a secondary sensor in the rear side rocker panel as part of the non-contact obstacle detection system on a vehicle, in accordance with an illustrative embodiment; and

FIGS. 47 to 49 are block diagrams illustrating radar based non-contact obstacle and gesture detection sensors for a motor vehicle according to aspects of the disclosure.

### DETAILED DESCRIPTION

In the following description, details are set forth to provide an understanding of the present disclosure. In some instances, certain circuits, structures, steps, and techniques have not been described or shown in detail in order not to obscure the disclosure.

In general, the present disclosure relates to a non-contact obstacle detection system of the type well-suited for use in many applications. More specifically, a side door non-contact obstacle detection (NCOD) system and a power swing door with a virtual handle assembly capable of gesture control for a motor vehicle and method of operating the non-contact obstacle detection system and the power swing door using the virtual handle assembly are disclosed herein. The non-contact obstacle detection system and virtual handle assembly of this disclosure will be described in conjunction with one or more example embodiments. However, the specific example embodiments disclosed are merely provided to describe the inventive concepts, features, advantages and objectives will sufficient clarity to permit those skilled in this art to understand and practice the disclosure.

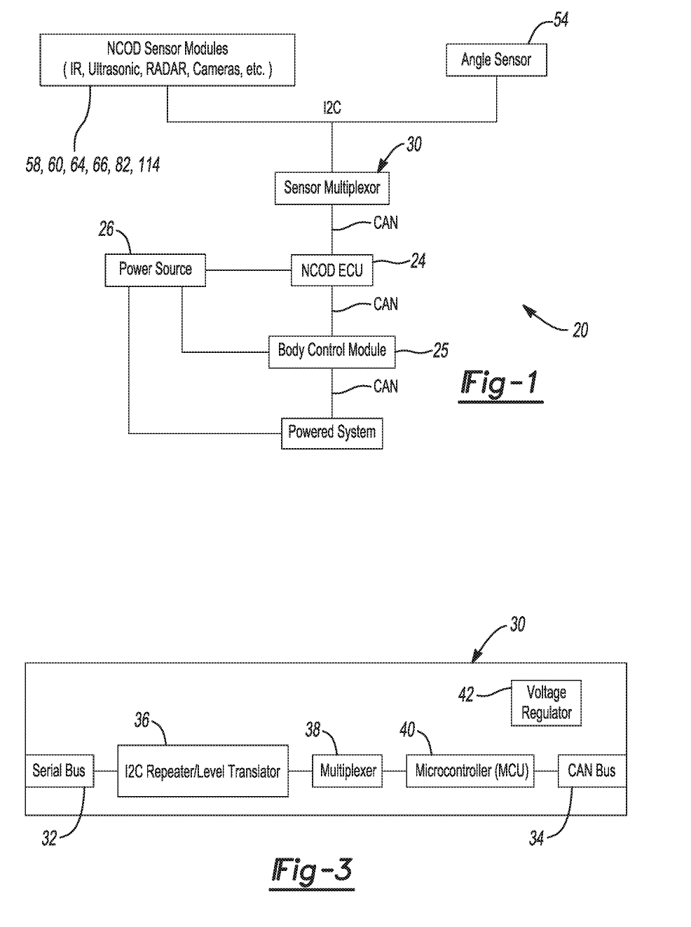

Referring to the Figures, wherein like numerals indicate corresponding parts throughout the several views, a non-contact obstacle detection system 20 for a motor vehicle 22 is disclosed. As best shown in FIGS. 1 and 2, the non-contact obstacle detection system 20 includes a main electronic control unit 24 that has a plurality of input-output terminals and is adapted to connect to a power source 26 and to a vehicle CAN bus 28 (controller area network).

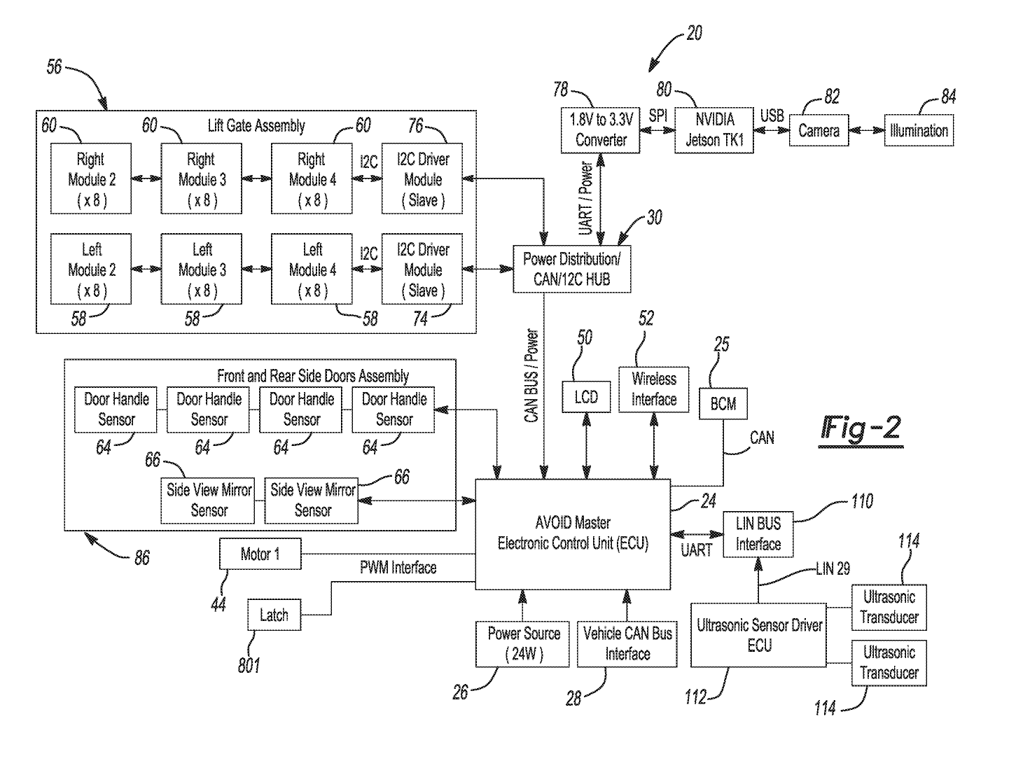

A sensor multiplexer hub 30 is coupled to at least one of the plurality of input-output terminals of the main electronic control unit 24 for providing power to the sensor multiplexer hub 30 and for communication with the main electronic control unit 24 via CAN communication. As best shown in FIG. 3, the sensor multiplexer hub 30 includes a hub serial bus interface 32 and a hub CAN bus interface 34. The sensor multiplexer hub 30 additionally includes a hub I²C repeater 36 coupled to the hub serial bus interface 32 to provide for communications on an I²C bus and a multiplexer 38 coupled to the hub I²C repeater 36. The hub I²C repeater 36 can also act as a level translator. In detail, Inter-Integrated Circuit (I²C) buses are generally a multi-master, multi-slave, single-ended, serial computer bus. The sensor multiplexer hub 30 additionally includes a hub microcontroller 40 coupled to the multiplexer 38 and to the hub CAN bus interface 34 and a hub voltage regulator 42 for regulating voltage supplied to the sensor multiplexer hub 30.

Referring back to FIG. 2, a motor 44 and/or a motor controller is also coupled to one of the plurality of input-output terminals of the main electronic control unit 24 (e.g., for moving a closure member of the vehicle 22, such as a swing door 46 or a lift gate 48) and may be operated with pulse width modulation by the main electronic control unit 24. Although only one motor 44 is described and shown in the Figures, it should be appreciated that any number of motors 44 may be utilized.

An LCD unit 50 is also coupled to one of the plurality of input-output terminals of the main electronic control unit 24 for displaying information related to the non-contact obstacle detection system 20 to a user (e.g., obstacle warning messages). A wireless interface unit 52 is also coupled to one of the plurality of input-output terminals of the main electronic control unit 24 for wireless communication. At least one angle sensor 54 (FIG. 1) may also be coupled to the sensor multiplexer hub 30. Alternatively, the sensor modules 58, 60, 64, 66, 82, 114 may be configured to detect angle of arrival of reflected radiation, such as infrared radiation. The angle sensor 54 could detect things such as, but not limited to the angle of a swing door 46 of the vehicle 22.

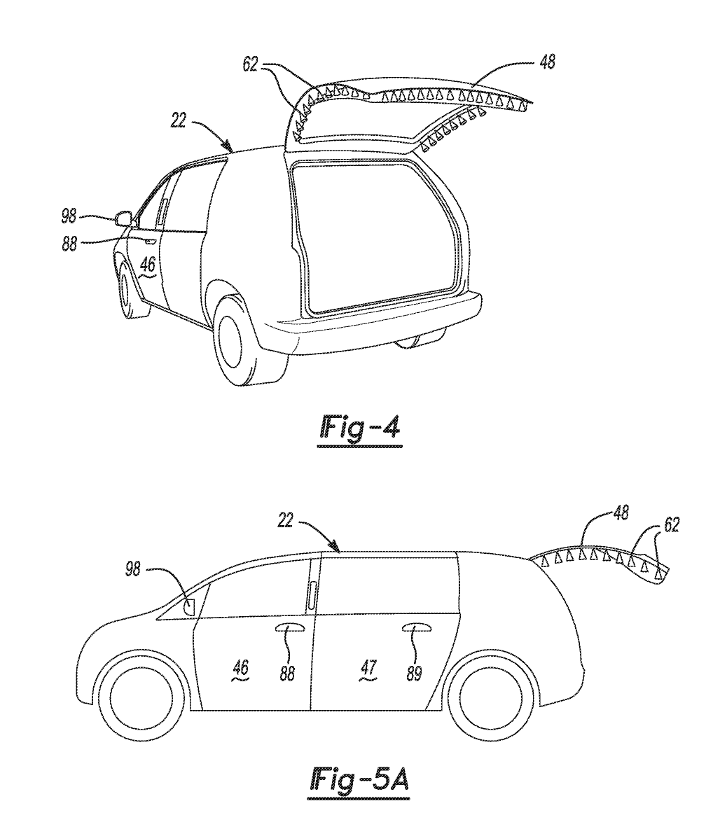

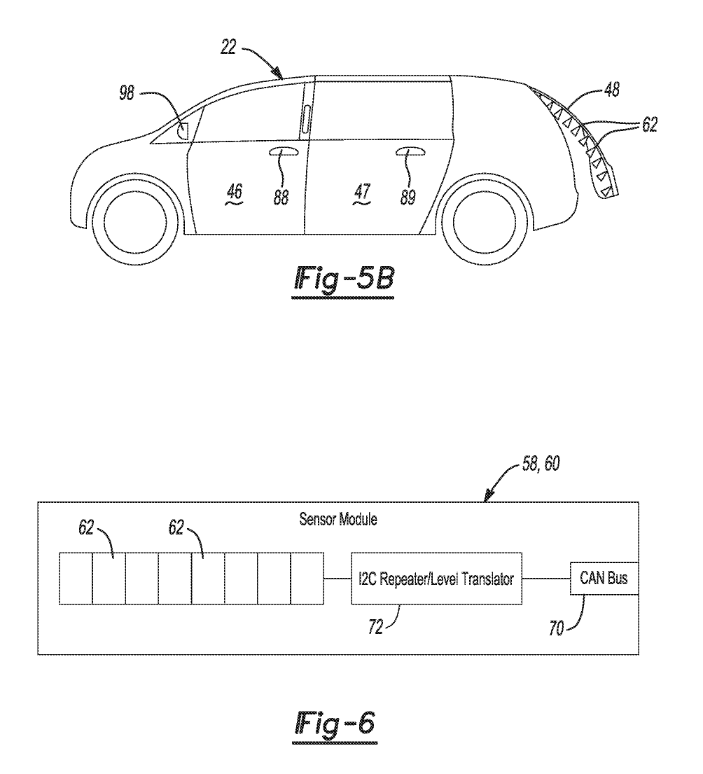

A lift gate sensor assembly 56 includes a plurality of left lift gate modules 58 and a plurality of right lift gate modules 60 for attachment to a lift gate 48 of a vehicle 22 (FIGS. 4 and 5A-5B) and for detecting obstacles near the lift gate 48 and for outputting lift gate sensor signals. The plurality of left lift gate modules 58 may be provided about the left perimeter of the lift gate 48 while the plurality of right lift gate modules 60 may be provided about the left perimeter of the lift gate 48. Additional lift gate modules as in 58, 60 (not shown) may be provided also along a bottom perimeter of the lift gate 48. The quantity of lift gate modules 58, 60 depends on the size and shape of the lift gate 48. According to an aspect, the lift gate modules 58, 60 are infrared time of flight sensors. However, it should be understood that the lift gate modules 58, 60 could instead be infrared sensors that are not used as time of flight sensors, for example. Time of flight (TOF) sensing allows an absolute distance to be measured independently of a target's reflectance. Sensors utilizing this technology measure the amount of time it takes light to travel from an emitter to the target and back (i.e., time of flight). As described herein, the sensors preferably utilize infrared (IR) light emission with an 850 nanometer wavelength. It should be understood that other wavelengths may be used in the alternative. Infrared modules or sensors as used herein can each include a transmitter for transmitting an infrared beam and a receiver for receiving the infrared beam after reflection from the target or object near the sensor and for outputting an IR signal to a processing unit.

As best shown in FIG. 6, the left and right lift gate modules 58, 60 each include a lift gate module CAN bus interface 70 and a plurality of lift gate proximity sensors 62. The lift gate proximity sensors 62 can, for example, have a range of approximately 40 centimeters. The left and right lift gate modules 58, 60 each also include a lift gate module I²C repeater 72 coupled to the lift gate proximity sensors 62 and to the lift gate module CAN bus interface 70.

Referring back to FIG. 2, the lift gate sensor assembly 56 includes a left I²C module 74 coupled to the left lift gate modules 58 for communicating the lift gate sensor signals from the left lift gate modules 58 to the sensor multiplexer hub 30. Similarly, the lift gate sensor assembly 56 additionally includes a right I²C module 76 coupled to the right lift gate modules 60 for communicating the lift gate sensor signals from the right lift gate modules 60 to the sensor multiplexer hub 30. The left I²C module 74 and the right I²C module 76 of the lift gate assembly 56 are coupled to the sensor multiplexer hub 30 for providing power to the lift gate sensor assembly 56 and for communication between the main electronic control unit 24 and the lift gate sensor assembly 56. It should be appreciated that the plurality of lift gate proximity sensors 62 could instead comprise sensors utilizing ultrasonic transducers or radar.

A graphics voltage converter 78 is coupled to the sensor multiplexer hub 30 for converting an input voltage from the sensor multiplexer hub 30 to a graphics output voltage. A GPU 80 (graphics processing unit) is coupled to the graphics voltage converter 78 and configured to operate using the graphics output voltage from the graphics voltage converter 78 for processing graphics data. A camera 82 is coupled to the GPU 80 for attachment to the vehicle 22 and for capturing computer vision imaging. An illumination unit 84 is coupled to the camera 82 for providing illumination for the computer vision imaging by the camera 82. The camera 82 may include complementary metal oxide semi-conductor (CMOS) charge-coupled device (CCD) type image sensors, for example. The camera 82 can generate imaging of a target area and can, for example, be used for determining speed or direction of an object (e.g., an obstacle), the shape and/or contour of the object, and/or otherwise assist the non-contact obstacle detection. As such, various sensor technologies can be operate together to complement one another. The system 20 described herein can incorporate a number of diverse sensor technologies (i.e., any two or more of these sensing technologies working in tandem in a hybrid concept). This will enable the system 20 to operate in distinct environmental conditions and will make it robust enough to be used in an automotive environment.

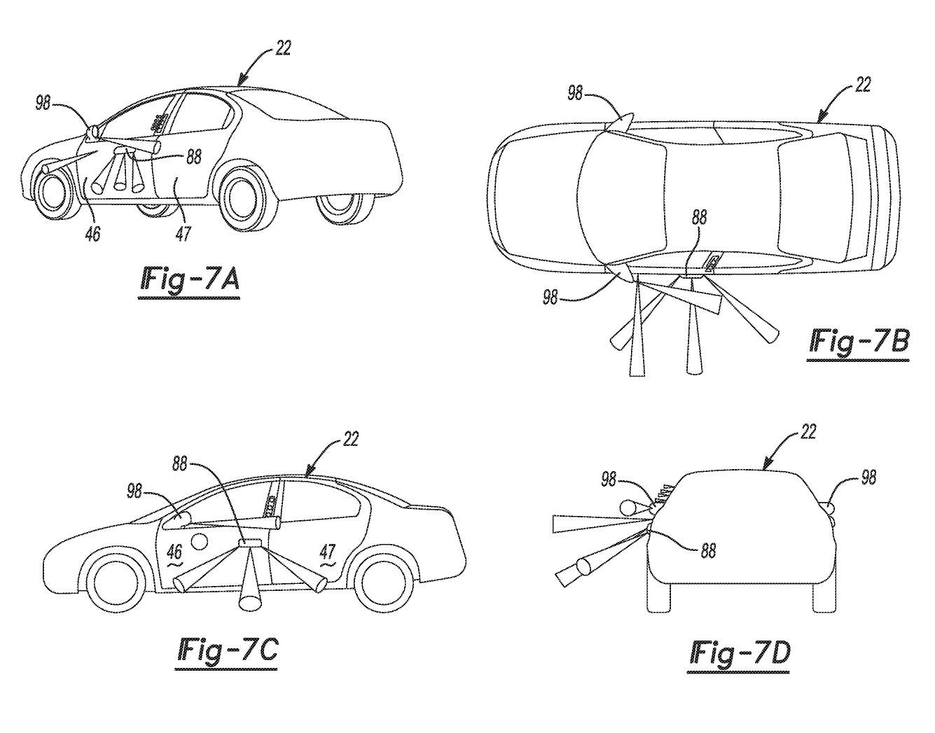

A front and rear side door sensor assembly 86 includes a plurality of door handle sensors 64 each for attachment to one of a front side door handle 88 and a rear side door handle 89 (FIGS. 7A-7D) and for detecting obstacles near the front and rear side door handles 88, 89. Each of the plurality of door handle sensors 64 can have a 1 meter range, for example. The plurality of door handle sensors 64 are coupled to one another and to at least one of the plurality of input-output terminals of the main electronic control unit 24.

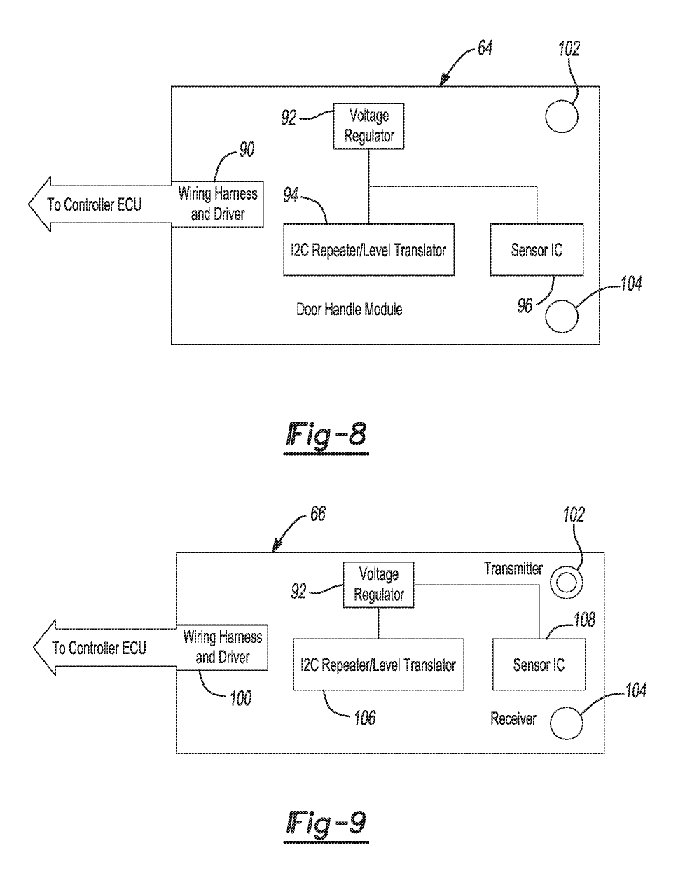

As best shown in FIG. 8, the plurality of door handle sensors 64 each include a door handle wiring harness connector 90 and a door handle voltage regulator 92 coupled to the door handle wiring harness connector 90 for regulating a door handle input voltage and outputting a door handle output voltage. The plurality of door handle sensors 64 each also include a door handle I²C repeater 94 coupled to the door handle voltage regulator 92 and to the door handle wiring harness connector 90 and a door handle sensor IC 96 coupled to the door handle I²C repeater 94 and the door handle voltage regulator 92. According to an aspect, the plurality of door handle sensors 64 are infrared time of flight sensors. However, it should be understood that the plurality of door handle sensors 64 could instead be infrared sensors that are not used as TOF sensors, but for example they could be intensity detection sensors or capabilities. It should also be appreciated that the plurality of door handle sensors 64 could instead comprise sensors utilizing ultrasonic transducers or radar.

The front and rear side door sensor assembly 86 also includes a plurality of side view mirror sensors 66 for attachment to one of a right and a left side view mirror 98 (FIGS. 7A-7D) and for detecting obstacles near the right and left side view mirrors 98. The plurality of side view mirror sensors 66 are coupled to one another and to at least one of the plurality of input-output terminals of the main electronic control unit 24 (FIG. 2).

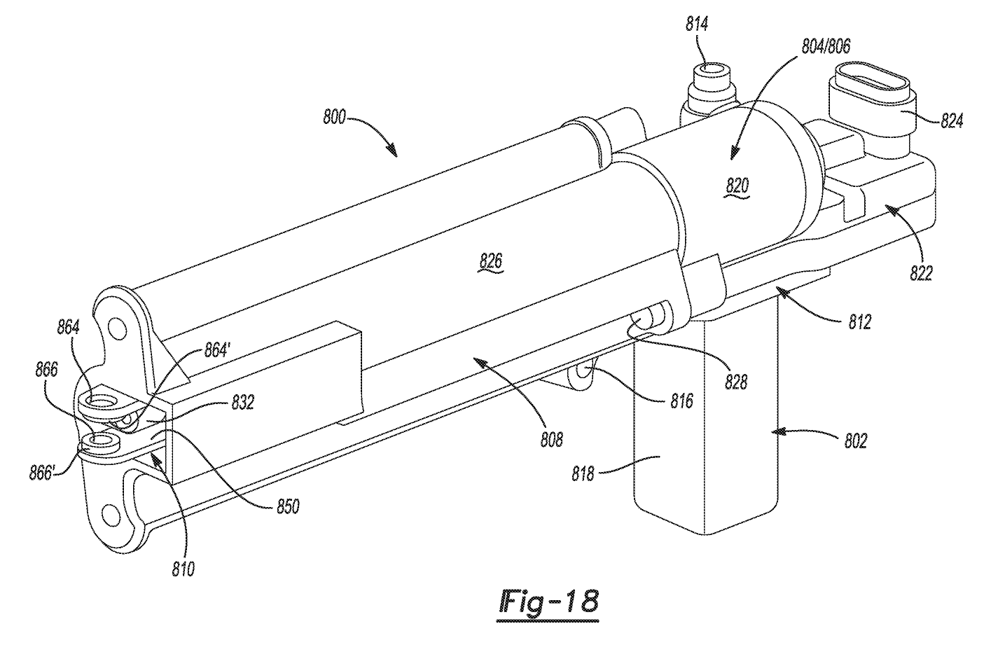

As best shown in FIG. 9, the plurality of side view mirror sensors 66 each include a side view mirror wiring harness connector and driver 100 and a side view mirror transmitter 102 (e.g., IR light emitting diode transmitter) for transmitting a side view beam. The plurality of side view mirror sensors 66 each also include a side view mirror receiver 104 (e.g., photodiode) for receiving a reflected side view beam in response to the transmission of the side view beam by the side view mirror transmitter 102. A side view mirror I²C repeater 106 is coupled to the side view mirror wiring harness connector and driver 100. A side view mirror sensor IC 108 (integrated circuit, shown in detail in FIG. 18) is coupled to the side view mirror transmitter 102 and the side view mirror receiver 104 and to the side view mirror I²C repeater 106. According to an aspect, the plurality of side view mirror sensors 66 are infrared time of flight sensors. However, it should be understood that the plurality of side view mirror sensors 66 could instead be infrared sensors that are not used as TOF sensors, but for example they could be intensity sensors. It should also be appreciated that the plurality of side view mirror sensors 66 could instead comprise sensors utilizing ultrasonic transducers or radar. The plurality of side view mirror sensors 66 can also be used during motion of the vehicle 22 for monitoring blind spots.

A LIN bus interface unit 110 (FIG. 2) is coupled to at least one of the plurality of input-output terminals of the main electronic control unit 24. The LIN bus interface provides for communication over a Local interconnect network (LIN). Local interconnect network provides for communication between components on the vehicle 22 via a serial network protocol. The CAN bus 28 may also be complemented by the LIN bus 29. An ultrasonic sensor driver ECU 112 (electronic control unit) is coupled to the LIN bus interface. A plurality of ultrasonic transducers 114 are coupled to the ultrasonic sensor driver ECU 112 for attachment to at least one of a front and a rear power swing door 47 (e.g., belt line or rocker panel location of the vehicle 22) and for detecting obstacles near the front and rear power swing doors 46, 47. The plurality of ultrasonic transducers 114 may alternatively be replaced by sensor modules similar to those of the lift gate sensor assembly 56 and the front and rear side door sensor assembly 86, as described herein, at such locations (e.g., belt line or rocker panel location of the vehicle 22). It should be appreciated that the plurality of ultrasonic transducers 114 could instead comprise sensors utilizing infrared technology or radar.

While the main electronic control unit 24 is illustratively described hereinabove as being in communication with the lift gate sensor assembly 56 and the front and rear side door sensor assembly 86 over the vehicle CAN bus 28, the main electronic control unit 24 may alternatively be in direct communication with the sensors 58, 60, 64, 66 and may be integrated with in the modules 56, 86 and be in communication with the Body Control Module (BCM) 25 over the vehicle CAN bus 28. Also, the main electronic control unit 24 may alternatively be coupled to the BCM 25 for forwarding to the BCM 25 a request for a desired operation of the closure member of the vehicle 22, or data about a detection of an obstacle, (e.g., the main electronic control unit 24 may issue a request for controlling a closure member of the vehicle 22, such as a swing door 46 or a lift gate 48, based on detection of an obstacle, or may forward information about the detection of the obstacle for decisions to be made by the BCM 25). The BCM 25 thus may rather operate the motor 44 and/or a motor controller based on such request or information, as well as in consideration with other decision criteria such as authentication information (e.g. presence of a key FOB, and other vehicle states).

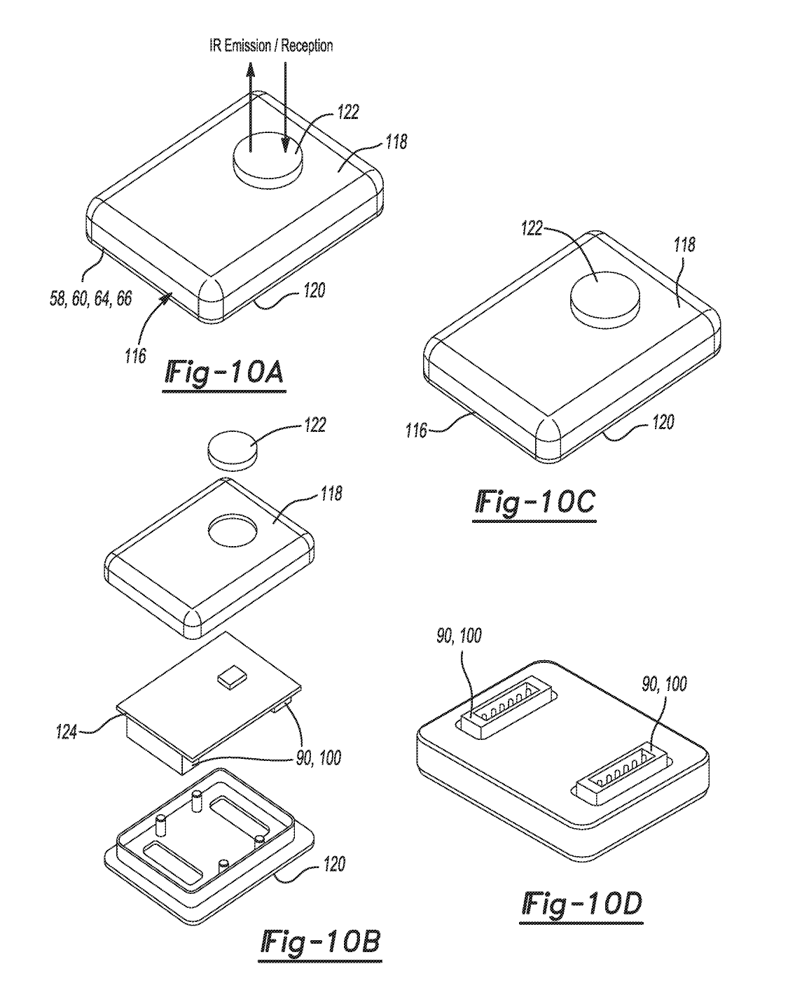

As best shown in FIGS. 10A-10D, each of the lift gate modules 58, 60, door handle sensors 64, and side view mirror sensors 66 can include a housing assembly 116 that comprises a housing top 118 and a housing bottom 120, each made of plastic (e.g., polypropylene and/or acrylonitrile butadiene styrene), for example. The housing top 118 includes an opening containing a window 122 of acrylic (e.g., that is transparent to infrared light). In detail, the window 122 has a low friction coating (such as an omniphobic coating like fluorodecyl POSS), so that dirt/contamination cannot adhere to the window 122. The window 122 must remain debris free to permit the infrared sensor to function effectively. A heater could also be added to the housing assembly 116 to melt snow or ice off of the window 122.In the configuration that a radar based sensor is used, the window 122 can be eliminated since radiation from such a sensor can penetrate the housing assembly 116 made from plastic. A sensor printed circuit board 124 (FIG. 10B) that has a sensor IC 96, 108 attached as well as a plurality of wiring harness connectors (e.g., door handle wiring harness connector 90 or side view mirror wiring harness connector 100) is disposed within the housing assembly 116. The housing bottom 120 can include one or more apertures to accommodate the wiring harness connectors. While such a specific structure may be utilized, it should be understood that each of the lift gate modules 58, 60, door handle sensors 64, and side view mirror sensors 66 may take other forms.

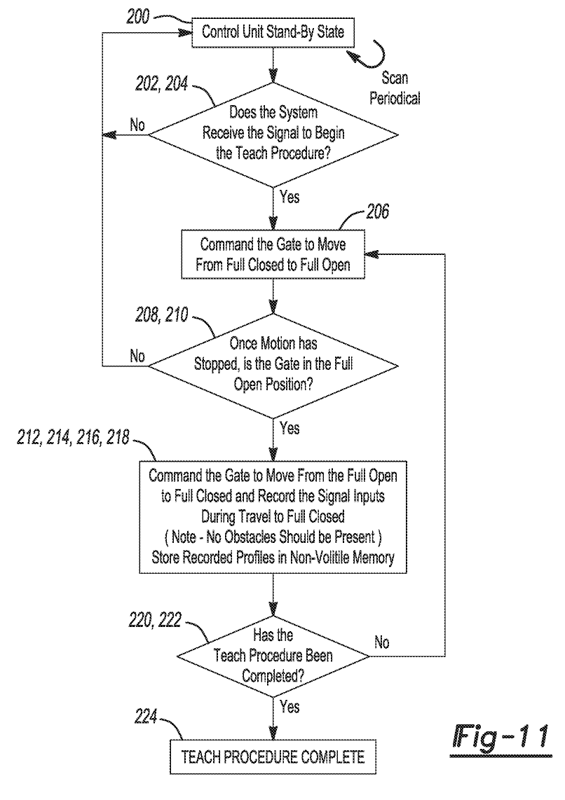

As illustrated in FIG. 11, a method of teaching a plurality of lift gate modules 58, 60 is also disclosed and includes the step of 200 maintaining the main electronic control unit 24 in a stand-by state. Then, 202 periodically scanning for a lift gate teach signal using the main electronic control unit 24 in the stand-by state. The method proceeds by 204 returning to the stand-by state in response to not detecting the lift gate teach signal. Next, 206 commanding a lift gate 48 to move from a full closed position to a full open position in response to detecting the lift gate teach signal. The method proceeds by, 208 determining whether the lift gate 48 is in the full open position once motion of the lift gate 48 has ceased. The next step of the method is 210 returning to the stand-by state in response to a determination that the lift gate 48 is not in the full open position. Then, 212 commanding the lift gate 48 to move from the full open position to the full closed position in response to determining that the lift gate 48 is in the full open position. The method continues by, 214 recording a plurality of lift gate signals from the lift gate modules 58, 60 using the main electronic control unit 24 during movement of the lift gate 48 to the full closed position. The method also includes the steps of 216 generating a plurality of recorded profiles based on the plurality of lift gate 48 signals and 218 storing the plurality of recorded profiles in a non-volatile memory. Then, the method includes the step of 220 determining whether the method of teaching the plurality of lift gate modules 58, 60 has been completed. Then, 222 returning to the step of commanding the lift gate 48 to move from the full closed position to the full open position (i.e., step) in response to a determination that the method of teaching has not been completed. The method concludes by, 224 ending the method of teaching the plurality of lift gate modules 58, 60 in response to determining that the method of teaching the plurality of lift gate modules 58, 60 has been completed. During normal cycling of the lift gate 48, the system will compare the data from this method of teaching (i.e., recorded profiles) to real-time data to determine if there is an object or obstacle present.

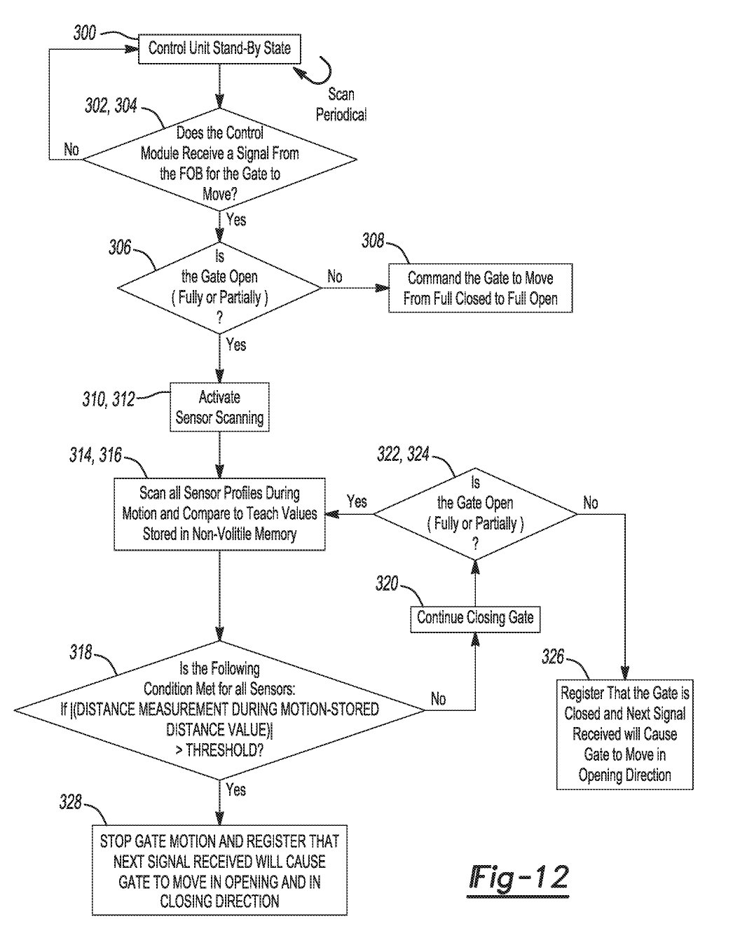

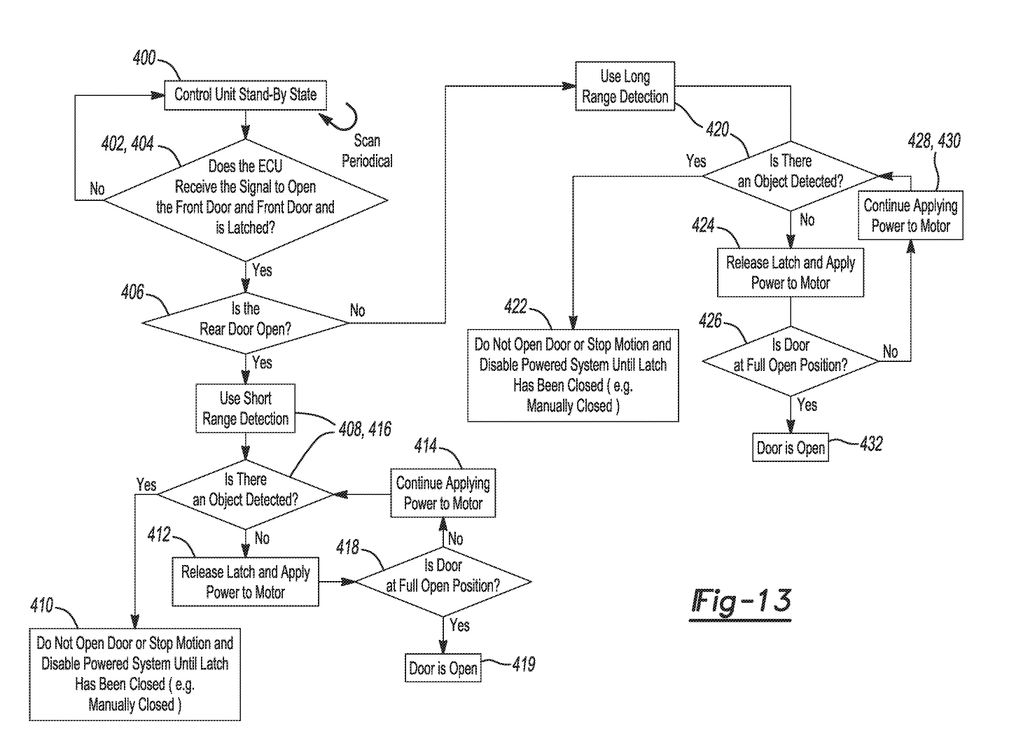

As best shown in FIG. 12, a method of operating a lift gate 48 having a plurality of lift gate modules 58, 60 is also disclosed and includes the step of 300 maintaining the main electronic control unit 24 in a stand-by state. Then, 302 periodically scanning for a lift gate fob signal using the main electronic control unit 24 in the stand-by state and 304 returning to the stand-by state in response to not detecting the lift gate fob signal. The method continues by, 306 determining whether the lift gate 48 is in an open position in response to detecting the lift gate fob signal.

The method of operating a lift gate 48 having a plurality of lift gate modules 58, 60 proceeds by, 308 commanding the lift gate 48 to move from a full closed position to a full open position in response to a determination that the lift gate 48 is not in the open position. Next, 310 commanding the lift gate 48 to move from the full open position to the full closed position and 312 activating a scan of a plurality of lift gate signals from a plurality of lift gate modules 58, 60. The next step of the method is 314 generating a plurality of lift gate sensor profiles based on the plurality of lift gate 48 signals. Then, 316 comparing the plurality of lift gate sensor profiles to a plurality of stored recorded profiles.

The method of operating a lift gate 48 having a plurality of lift gate modules 58, 60 then includes the step of 318 determining whether a difference between a distance measured during motion of the lift gate 48 and a stored distance value exceeds a threshold (e.g., a maximum amount that the distance measured during motion of the lift gate 48 and the stored distance value from the stored recorded profiles are allowed to be different). The method also includes the step of 320 continuing to close the lift gate 48 in response to a determination that the difference between the distance measured during motion of the lift gate 48 and the stored distance value does not exceed the threshold.

The method of operating a lift gate 48 having a plurality of lift gate modules 58, 60 also includes the step of 322 determining whether the lift gate 48 is in the open position and 324 returning to the step of generating a plurality of lift gate sensor profiles based on the plurality of lift gate signals in response to a determination that the lift gate 48 is in the open position. The next step of the method is 326 registering that the lift gate 48 is closed and the next lift gate fob signal will cause the lift gate 48 to move in an opening direction in response to a determination that the lift gate 48 is not in the open position. The method concludes by, 328 stopping motion of the lift gate 48 and 330 registering that the next lift gate fob signal will cause the lift gate 48 to move in the opening direction in response to a determination that the difference between the distance measured during motion of the lift gate 48 and the stored distance value exceeds the threshold.

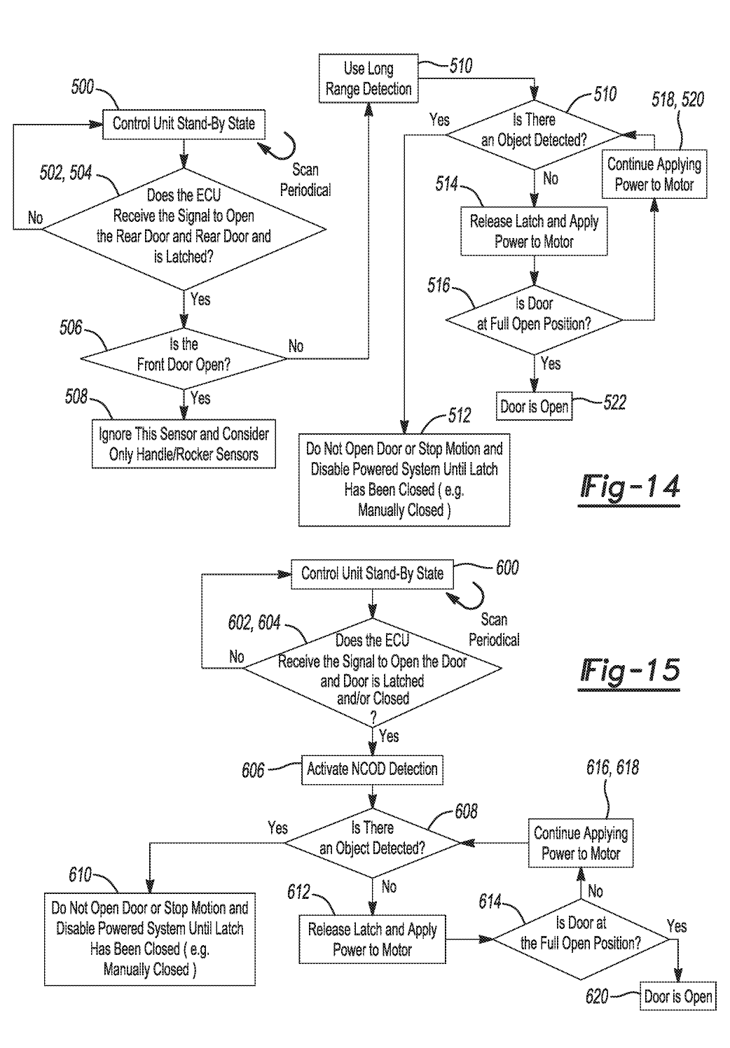

As illustrated in FIG. 13, a method of operating a front door (e.g., swing door 46) having a side view mirror sensor 66 is additionally disclosed and includes the step of 400 maintaining the main electronic control unit 24 in a stand-by state. Then, 402 periodically scanning for a front door opening signal using the main electronic control unit 24 in the stand-by state. The next step of the method is 404 returning to the stand-by state in response to not detecting the front door opening signal.

The method of operating a front door having a side view mirror sensor 66 also includes the step of 406 determining whether a rear door is in an open position in response to detecting the front door opening signal. The method proceeds by, 408 detecting if an obstacle is detected using short range detection with the plurality of side view mirror sensors 66 in response a determination that the rear door is in the open position. Next, 410 ceasing door opening and disabling system in response to the obstacle being detected.

The method of operating a front door having a side view mirror sensor 66 proceeds by, 412 releasing a latch 801 engageable with a striker (not shown) affixed to the vehicle body and applying power to a motor 44 in response to the obstacle not being detected and determining whether the front door is in a full open position. The next step of the method is 414 continuing to apply power to the motor 44 in response to a determination that the front door is not in the full open position. The method also includes the steps of 416 returning to the step of detecting if the obstacle is detected using short range detection and 418 concluding that the front door 46 is open in response to a 419 determination that the front door 46 is in the full open position.

The method of operating a front door 46 having a side view mirror sensor 66 continues with the step of 420 detecting if the obstacle is detected using long range detection with the plurality of side view mirror sensors 66 in response to a determination that the rear door is not in the open position. Then, the method includes the step of 422 ceasing door opening and disabling system in response to the obstacle being detected. The method proceeds by, 424 releasing the latch 801 and applying power to the motor 44 in response to the obstacle not being detected.

The method operating a front door having a side view mirror sensor 66 then includes the step of 426 determining whether the front door is in the full open position. Next, 428 continuing to apply power to the motor 44 in response to a determination that the front door is not in the full open position. The method proceeds by, 430 returning to the step of detecting if the obstacle is detected using long range detection. The method then completes with the step of 432 concluding that the front door is open in response to a determination that the front door is in the full open position.

As illustrated in FIG. 14, a method of operating a rear door using a side view mirror sensor 66 is also disclosed and includes the step of 500 maintaining the main electronic control unit 24 in a stand-by state. Then, 502 periodically scanning for a rear door opening signal using the main electronic control unit 24 in the stand-by state and 504 returning to the stand-by state in response to not detecting the front door opening signal.

The method of operating a rear door using a side view mirror sensor 66 continues with the step of 506 determining whether a front door 46 is in an open position in response to detecting the front door opening signal. Then, 508 ignoring the side view mirror sensor 66 of the front door in response to a determination that the front door 46 is in the open position. The next step of the method is 510 detecting if an obstacle is detected using long range detection with the side view mirror sensor 66 in response to a determination that the front door 46 is not in the open position. The method continues by 512 ceasing door opening and disabling system in response to the obstacle being detected.

The method of operating a rear door using a side view mirror sensor 66 also includes the step of 514 releasing the latch 801 and applying power to the motor 44 in response to the obstacle not being detected. Next, 516 determining whether the rear door is in the full open position and 518 continuing to apply power to the motor 44 in response to a determination that the front door 46 is not in the full open position. The method continues by, 520 returning to the step of detecting if the obstacle is detected using long range detection. The final step of the method is 522 concluding that the rear door is open in response to a determination that the rear door is in the full open position.

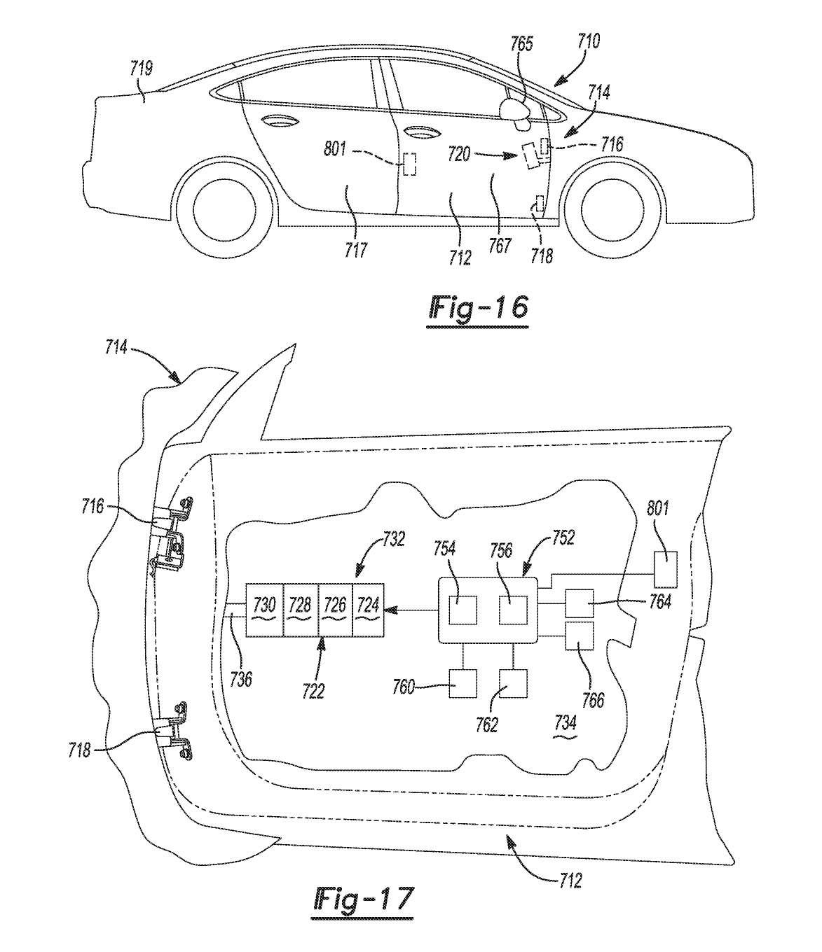

As illustrated in FIG. 15, a method of operating a side door (e.g., swing door 46) having a door handle sensor 64 is additionally disclosed and includes the step of 600 maintaining the main electronic control unit 24 in a stand-by state. Then, 602 periodically scanning for a side door opening signal using the main electronic control unit 24 in the stand-by state. The method continues by 604 returning to the stand-by state in response to not detecting the side door opening signal.

The method of operating a side door having a door handle sensor 64 also includes the step of 606 activating non-contact obstacle detection in response to detecting the side door opening signal. Next, 608 detecting if an obstacle is detected using the door handle sensor 64 in response a determination that the side door is not in the open position. The method proceeds by 610 ceasing door opening and disabling the system in response to the obstacle being detected.

The method of operating a side door having a door handle sensor 64 also includes the step of 612 releasing the latch 801 and applying power to the motor 44 in response to the obstacle not being detected. Then, 614 determining whether the side door is in the full open position. The method then includes the step of 616 continuing to apply power to the motor 44 in response to a determination that the front door is not in the full open position. Next, 618 returning to the step of detecting if the obstacle is detected using the door handle sensor 64 and 620 concluding that the side door is open in response to a determination that the side door is in the full open position.

Referring initially to FIG. 16, an example motor vehicle 710 is shown to include a first passenger door 712 pivotally mounted to a vehicle body 714 via an upper door hinge 716 and a lower door hinge 718 which are shown in phantom lines. In accordance with the present disclosure, an actuation system (e.g., power door actuation system 720) is integrated into the pivotal connection between first passenger door 712 and a vehicle body 714. The power door actuation system 720 can be integrated into the obstacle detection system of the present disclosure. In accordance with a preferred configuration, power door actuation system 720 generally includes a power-operated swing door actuator secured within an internal cavity of passenger door 712 and including an electric motor driving a spindle drive mechanism having an extensible component that is pivotably coupled to a portion of the vehicle body 714. Driven rotation of the spindle drive mechanism causes controlled pivotal movement of passenger door 712 relative to vehicle body 714.

Each of upper door hinge 716 and lower door hinge 718 include a door-mounting hinge component and a body-mounted hinge component that are pivotably interconnected by a hinge pin or post. While power door actuation system 720 is only shown in association with front passenger door 712, those skilled in the art will recognize that actuation systems, such as the power door actuation system 720 can also be associated with any closure member, such as but not limited to other doors or lift gate of vehicle 710 such as rear passenger doors 717 and decklid 719.

Power door actuation system 720 is diagrammatically shown in FIG. 17 to include a power swing door actuator 722 configured to include an electric motor 724, a reduction geartrain 726, a slip clutch 728, and a drive mechanism 730 which together define a power assembly 732 that is mounted within an interior chamber 734 of door 712. Power swing door actuator 722 further includes a connector mechanism 736 configured to connect an extensible member of drive mechanism 730 to vehicle body 714. As also shown, an electronic control module 752 is in communication with electric motor 724 for providing electric control signals thereto. Electronic control module 752 can include a microprocessor 754 and a memory 756 having executable computer readable instructions stored thereon.

Although not expressly illustrated, electric motor 724 can include Hall-effect sensors for monitoring a position and speed of vehicle door 712 during movement between its open and closed positions. For example, one or more Hall-effect sensors may be provided and positioned to send signals to electronic control module 752 that are indicative of rotational movement of electric motor 724 and indicative of the opening speed of vehicle door 46, e.g., based on counting signals from the Hall-effect sensor detecting a target on a motor output shaft. In situations where the sensed motor speed is greater than a threshold speed and where the current sensor registers a significant change in the current draw, electronic control module 752 may determine that the user is manually moving door 712 while motor 724 is also operating, thus moving vehicle door 712 between its open and closed positions. Electronic control module 752 may then send a signal to electric motor 724 to stop motor 724 and may even disengage slip clutch 728 (if provided). Conversely, when electronic control module 752 is in a power open or power close mode and the Hall-effect sensors indicate that a speed of electric motor 724 is less than a threshold speed (e.g., zero) and a current spike is registered, electronic control module 752 may determine that an obstacle is in the way of vehicle door 712, in which case the electronic control system may take any suitable action, such as sending a signal to turn off electric motor 724. As such, electronic control module 752 receives feedback from the Hall-effect sensors to ensure that a contact obstacle has not occurred during movement of vehicle door 712 from the closed position to the open position, or vice versa.

As is also schematically shown in FIG. 17, electronic control module 752 can be in communication with a remote key fob 760 or an internal/external handle switch 762 for receiving a request from a user to open or close vehicle door 712. Put another way, electronic control module 752 receives a command signal from either remote key fob 760 and/or internal/external handle switch 762 to initiate an opening or closing of vehicle door 712. Upon receiving a command, electronic control module 752 proceeds to provide a signal to electric motor 724 in the form of a pulse width modulated voltage (for speed control) to turn on motor 724 and initiate pivotal swinging movement of vehicle door 712. While providing the signal, electronic control module 752 also obtains feedback from the Hall-effect sensors of electric motor 724 to ensure that a contact obstacle has not occurred. If no obstacle is present, motor 724 will continue to generate a rotational force to actuate spindle drive mechanism 730. Once vehicle door 712 is positioned at the desired location, motor 724 is turned off and the “self-locking” gearing associated with gearbox 726 causes vehicle door 712 to continue to be held at that location. If a user tries to move vehicle door 712 to a different operating position, electric motor 724 will first resist the user's motion (thereby replicating a door check function) and eventually release and allow the door 712 to move to the newly desired location. Again, once vehicle door 712 is stopped, electronic control module 752 will provide the required power to electric motor 724 to hold it in that position. If the user provides a sufficiently large motion input to vehicle door 712 (i.e., as is the case when the user wants to close the door 712), electronic control module 752 will recognize this motion via the Hall effect pulses and proceed to execute a full closing operation for vehicle door 712.

Electronic control module 752 can also receive an additional input from a sensor, as previously disclosed herein, positioned on a portion of vehicle door 712, such as on a door mirror 765, or the like. Sensor 764 assesses if an obstacle, such as another car, tree, or post, is near or in close proximity to vehicle door 712. If such an obstacle is present, sensor 764 will send a signal to electronic control module 752, and electronic control module 752 will proceed to turn off electric motor 724 to stop movement of vehicle door 712, and thus prevent vehicle door 712 from hitting the obstacle. This provides a non-contact obstacle avoidance system. In addition, or optionally, a contact obstacle avoidance system can be placed in vehicle 710 which includes a contact sensor 766 mounted to door, such as in association with molding component 767, and operable to send a signal to controller 752.

Referring initially to FIGS. 18-21, power swing door actuator 800 is shown to generally include an electric motor 802, a reduction geartrain unit 804, a slip clutch unit 806, a spindle drive mechanism 808, and a linkage mechanism 810. Power actuator 800 also includes a mounting bracket 812 having one or more mounting apertures 814, 816 configured to receive fasteners (not shown) for securing bracket 812 to the vehicle door between the inner and outer panels thereof. A motor housing 818 associated with electric motor 802 is secured to mounting bracket 812. Likewise, a clutch housing 820 is secured to mounting bracket 812 and is configured to enclose geartrain unit 804 and clutch unit 806. An integrated controller unit 822 is also provided in associated with actuator 800 and may include a printed circuit board (not shown) and electronic circuitry and components required to control actuation of electric motor 802, as well as a plug-in connector 824 configured to provide electrical power to actuator 800. Finally, an elongated drive housing 826 is shown connected via fasteners 828 to clutch housing 820. While not limited thereto, mounting bracket 812 may be integrated with clutch housing 820 into a rigid mounting component configured to permit attachment thereto of motor housing 818, drive housing 826 and controller unit 822 to provide a compactly packaged actuator arrangement.

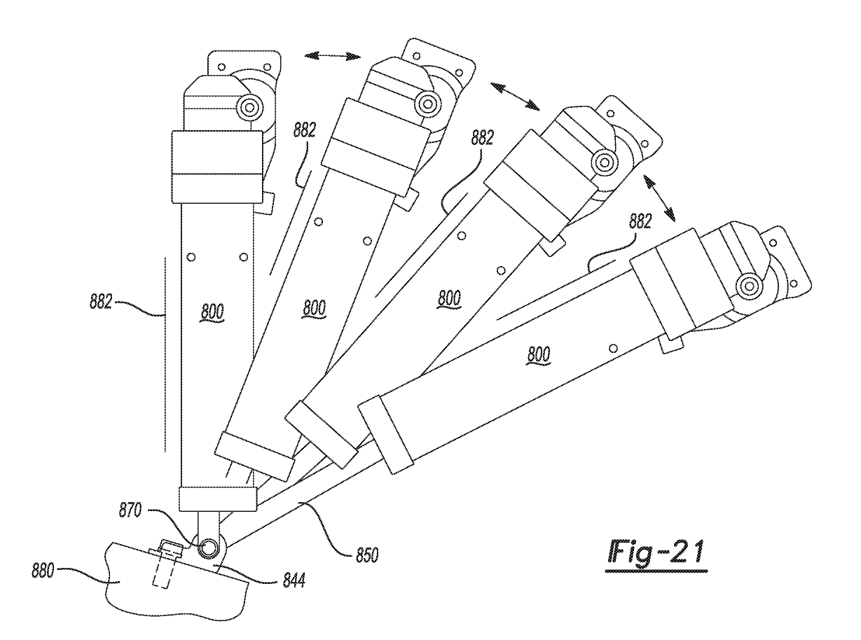

Electric motor 802 includes a rotary output shaft driving an input gear component of geartrain unit 804. An output gear component of geartrain unit 804 drives an input clutch member of clutch unit 806 which, in turn, drives an output clutch member of clutch unit 806 until a predetermined slip torque is applied therebetween. The output clutch member of clutch unit 806 drives an externally-threaded leadscrew 830 associated with spindle drive mechanism 808. A first end of leadscrew 830 is rotatably supported by a first bearing (not shown) within geartrain housing 820 while a second end of leadscrew 830 is rotatably supported in a bushing 832 mounted in linkage mechanism 810. Spindle drive mechanism 808 also includes an internally-threaded drive nut 834 in threaded engagement with externally-threaded leadscrew 830. Linkage mechanism 810 is generally configured to have a first end segment 840 pivotably connected to drive nut 834 and a second end segment 842 pivotably coupled to a body-mounted bracket 844 (FIG. 21). This incorporation of an articulatable linkage mechanism 810 between spindle drive mechanism 808 and the vehicle body accommodates swinging motion of the vehicle door 880 upon movement between its fully-closed and fully-open positions while permitting direct fixation of power swing door actuator 800 within a smaller internal packaging portion of the vehicle door.

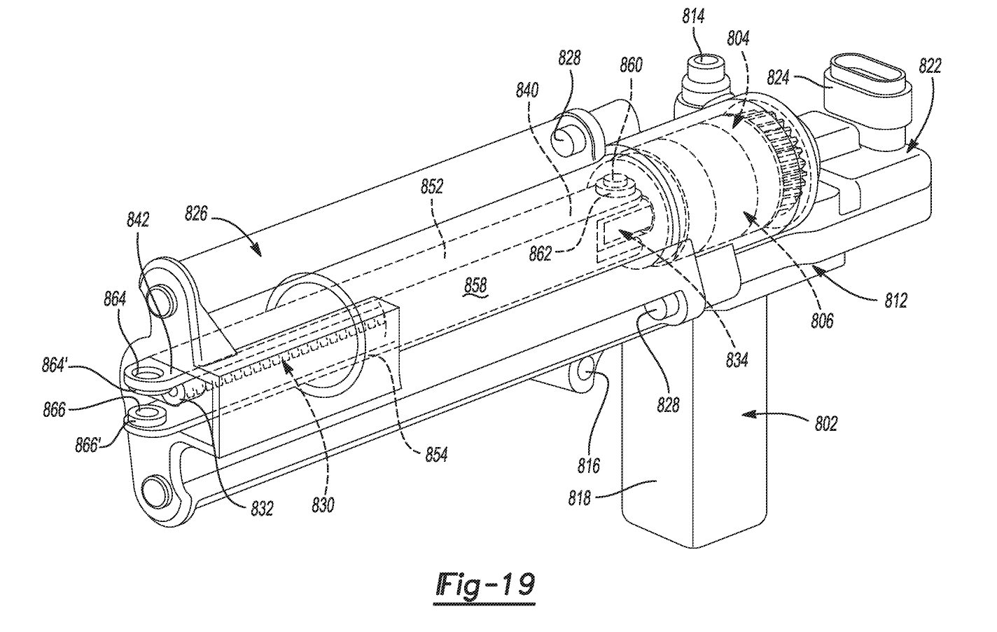

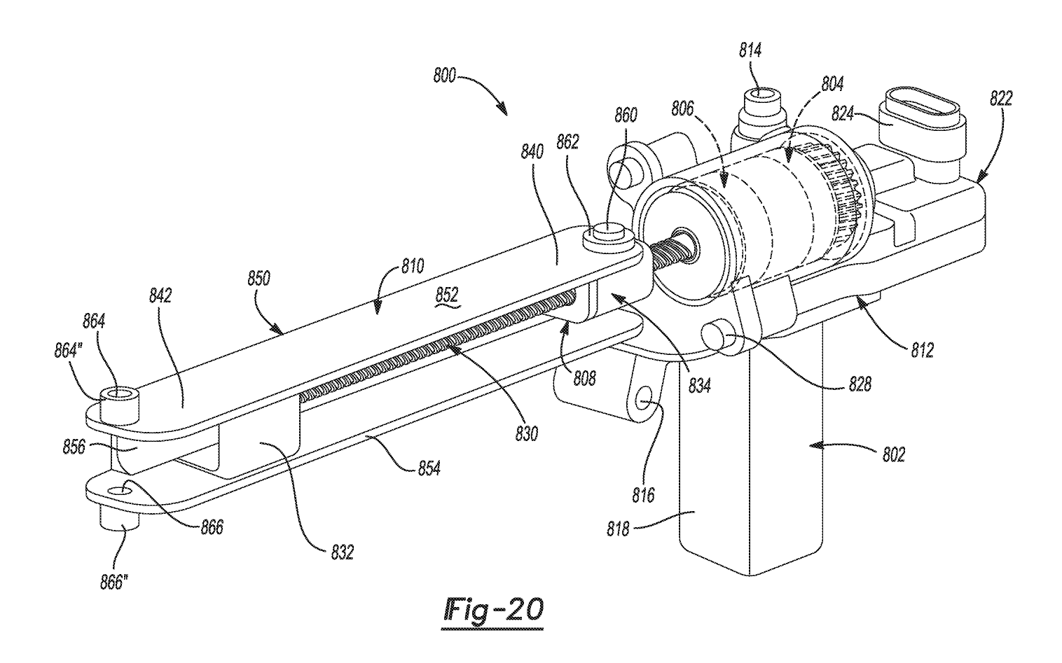

As best seen in FIGS. 19 and 20, linkage mechanism 810 includes a box-shape connector link 850 having a top plate 852 and a bottom plate 854 interconnected by a pair of laterally-spaced side plates 856, 858. Note that side plate 858 is removed in FIG. 20 to better illustrate threaded engagement of drive nut 834 with leadscrew 830. A pair of pivot posts 860 (only one shown) extend outwardly from opposite surfaces of drive nut 834 and are retained in aperture bosses 862 (only one shown) formed in top plate 852 and bottom plate 854. As such, first end segment 840 of connector link 850 is pivotably coupled to drive nut 834. Likewise, a pair of aligned pivot boss apertures 864, 866 formed in plates 852, 854 of connector link 850 are configured to receive a pivot post 870 for pivotably coupling second end segment 842 of connector link 850 to body-mounted bracket 844. FIGS. 18 and 19 show boss apertures 864, 866 with their support tube segments 864′, 866′ facing toward each other between plates 852, 854. In contrast, FIG. 20 illustrates the tube segments 864′, 866′ facing away from each other to illustrate an alternative construction. FIG. 20 best illustrates an enlarged section 870 of drive housing 826 formed adjacent second end segment 842 of connector link 850 and provided to accommodate angular movement of connector link 850 relative to drive housing 826 resulting from swinging movement of the door between its open and closed positions.

FIG. 21 illustrates movement of power actuator 800 relative to vehicle body 880 in response to actuation thereof causing movement of the vehicle door (line 882 indicates door inner panel) from its fully closed position to its fully open position. The two intermediate positions are shown for purposes of illustration only to indicate available checked positions of the vehicle door. To this end, drive nut 834 and connector link 850 are positioned in a fully retracted position within drive housing 826 when the door is closed. In contrast, drive nut 834 and connector link 850 are positioned in a fully extended position relative to drive housing 826 when the vehicle door is fully opened. The pivotable connection between first end segment 840 of connector link 850 and drive nut 834 also prevents rotation of drive nut 834 relative to drive housing 826. Since second end segment 842 connector link 850 is also pivotably secured to vehicle body 880 via pivot post 870 on mounting bracket 844, actuation of electric motor 802 actually converts rotation of leadscrew 830 into linear translation of counterlink 850. Such translation of leadscrew 830 results in corresponding translational movement of actuator 800. Since actuator 800 is directly secured to the door, rotation of leadscrew 830 in a first direction causes an opening door function while rotation of leadscrew 830 in a second direction causes a closing door function.

Power swing door actuator 800 provides both push and pull forces to operate a power door system, particularly passenger-type doors on motor vehicles. While power actuator 800 provides an electrical “checking” function, it is contemplated that mechanical checklink systems could easily be integrated with power actuator 800. Additionally, the articulating link configuration, when combined with a mechanical checking mechanism allows the powered swing door to have the same translating path as a non-powered checklink arrangement. The articulating linkage allows the checklink path to follow the same path as conventional checklink configurations, rather than a linear path. Integrating a checklink mechanism into power swing door actuator 800 would also permit elimination of a separate door check feature.

The power actuator 800 shown in FIGS. 18-21 is one non-limiting example of a power closure arrangement configured to be easily integrated into the non-contact obstacle detection system 20 of the present disclosure. Specifically, this is an example of a non-contact obstacle detection system 20 that can be used in association with the motor of the power actuator 800 to drive the closure member, and an absolute position sensor can be used to determine the full open position. Other powered devices, such as power release latches can be used with this non-contact obstacle detection system 20. For example, non-limiting examples of such power release latches are disclosed in US Publication No. 2015/0330116 and US Publication No. 2012/0313384, each of which is incorporated by reference herein. Similarly, a power lift gate actuator capable of association herewith is disclosed in WO 2014/199235 as is likewise incorporated herein. Finally, a powered strut device for use in power lift gate systems is disclosed in US Publication No. 2015/0376929 and its teachings are further incorporated herein by reference.

According to aspects of the disclosure, a virtual handle assembly 900 (FIG. 22) may also be utilized to control operation of the closure member (e.g., swing door 46) without physical contact by the hand 901 of a user (i.e. handsfree). The virtual handle assembly 900 can be attached to or disposed adjacent the closure member and coupled to the main electronic control unit 24 or controlled by another virtual handle control unit (e.g., integrated microcontroller), for example, and includes at least one virtual handle sensor 902 for detecting a hand 901 in proximity to the virtual handle assembly 900. In operation, the virtual handle assembly 900 measures the distance to the hand 901 and maintains the distance by operating the power-operated swing door actuation system 720 to move the closure member (e.g., swing door 46). If the key fob 760 is present, the virtual handle assembly 900 can scan for a hand 901 in front of the virtual handle sensor 902. If a hand 901 is present for a predetermined time (e.g., 5 seconds), the control system (microcontroller and/or main electronic unit 24) activates the virtual handle feature. If the hand 901 is moved away, a latch 801 can be released and the actuation system (e.g., power swing door actuator 800) drives the swing door 46 to maintain the distance to the hand 901 in both opening and closing directions. The virtual handle assembly 900 can also detect gestures that are made with the hand 901 (e.g., first or open hand).

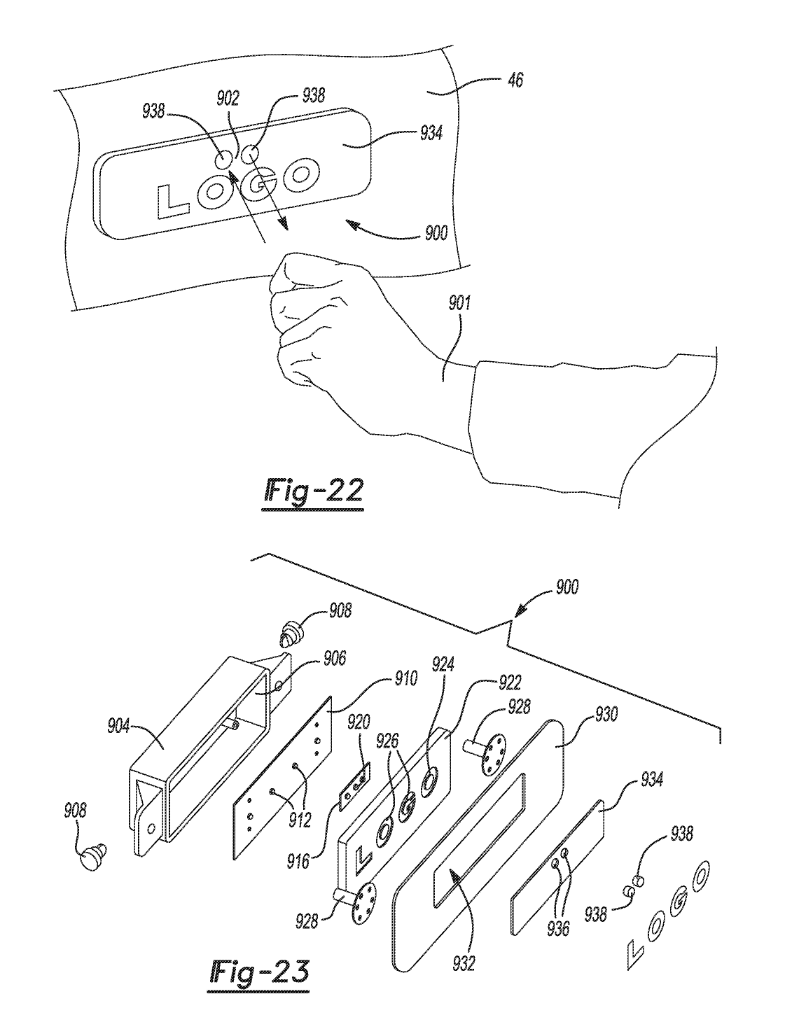

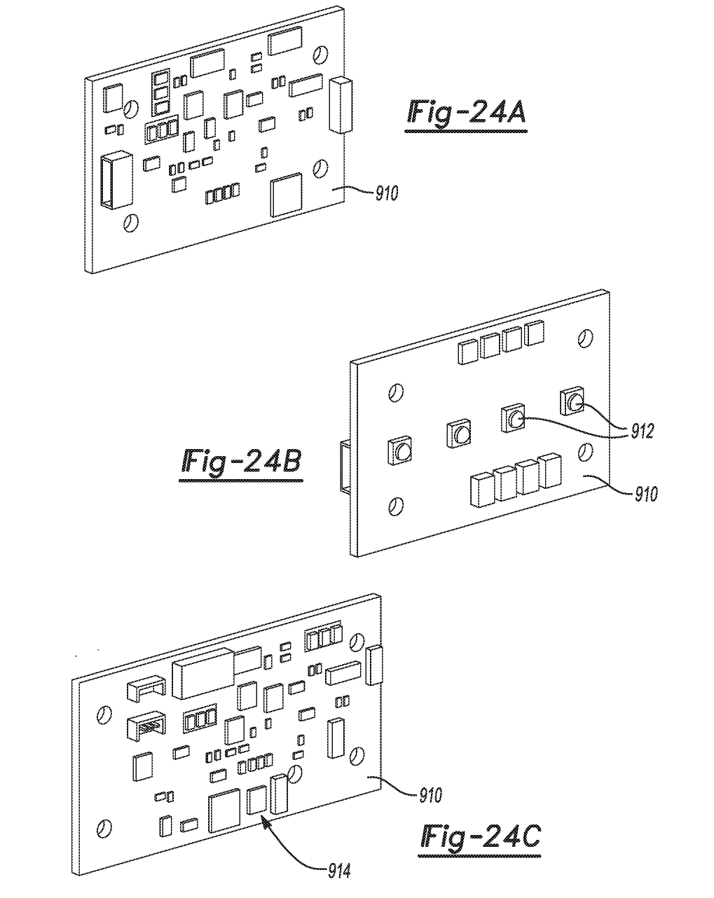

According to aspects of the disclosure and as best shown in FIG. 23, the virtual handle assembly 900 can include a handle housing 904 defining a compartment with at least one wiring opening 906 for the passage of wiring to the vehicle 22. The virtual handle assembly 900 may be positioned at various positions on the vehicle 22, for example it may be positioned in the front and rear side door handles 88, 89, in the appliqué for example in an applique 1200 of the swing door 46 or a B-pillar 1202, in the side door mirror 765, behind a window for example behind rear power sliding window 1300 of the motor vehicle 22, or at other positions on the vehicle door. At least one strain relief boot 908 is disposed in the at least one wiring opening 906 for relieving strain on the wiring to the vehicle 22. A driver microcontroller and accent LED printed circuit board 910 (also shown in FIGS. 24A-24C) is disposed within the compartment of the handle housing 904 and includes a plurality of multi-color LEDs 912 disposed thereon (e.g., on a first side of the driver microcontroller and accent LED printed circuit board 910) and a sensor microcontroller 914 disposed thereon (e.g., on a second side of the driver microcontroller and accent LED printed circuit board 910).

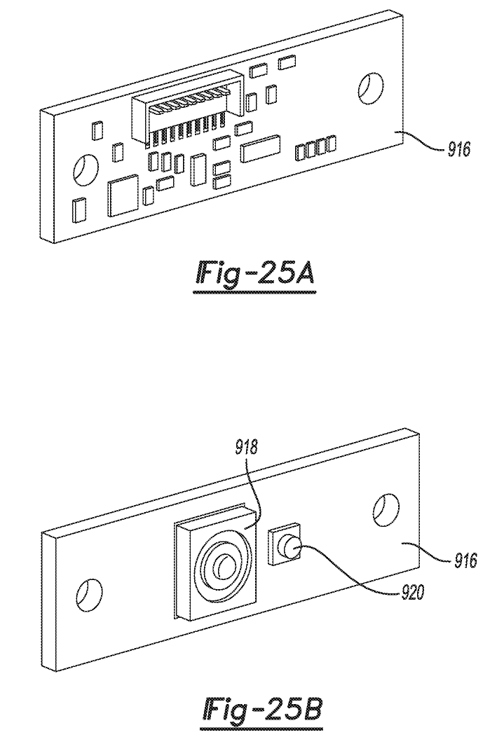

The virtual handle assembly 900 also includes a handle infrared sensor printed circuit board 916 (also shown in FIGS. 25A-25B) that is electrically coupled to the driver microcontroller and accent LED printed circuit board 910 (e.g., to communicate via I²C communications). The handle infrared sensor printed circuit board 916 includes a sensor LED 918 and the at least one virtual handle sensor 902, specifically an infrared photometric sensor 920 (e.g., a photometric sensor for gesture and proximity detection, commonly used for multiple optical measurement applications and proximity sensing). A cover plate 922 extends over the driver microcontroller and accent LED printed circuit board 910 and the handle infrared sensor printed circuit board 916 and defines a plurality of graphic openings 924 for allowing light from the plurality of multi-color LEDs 912 of the driver microcontroller and accent LED printed circuit board 910 to pass through the cover plate 922. The cover plate 922 additionally defines sensor openings 926 each aligned with the sensor LED 918 and an infrared photometric sensor 920, respectively. A plurality of studs 928 are disposed at opposite ends of the cover plate 922. A sheet metal plate 930 defining a central opening 932 extends over the cover plate 922 and an A-surface panel 934 is disposed in the central opening 932. The A-surface panel 934 defines a pair of panel openings 936 aligned with the sensor openings 926 and in which a plurality of infrared transmissive covers 938 are disposed. Thus, gesture and proximity detection by the infrared photometric sensor 920 is possible, because the plurality of infrared transmissive covers 938 are infrared transparent. It should be appreciated that the infrared transmissive covers 938 can be made of any material that enables infrared transmission. Nevertheless, a “focusing” lens is not necessary, as may be needed if a camera is utilized. The virtual handle assembly 900 outputs light as defined by the graphic openings 924 of the cover plate 922.

The infrared photometric sensor 920 of the handle infrared sensor printed circuit board 916 is shown in more detail in FIG. 26 and provides for the sensing of gestures and proximity of objects to the infrared photometric sensor 920. The infrared photometric sensor 920 includes a plurality of sensor connections 940 (e.g., to power and ground) and a position sensor 941 having four channels 942 which are coupled to a signal conditioning block 944. The signal conditioning block 944 couples to a gesture engine digital interface control logic block 946 through a sensor analog-digital-convertor (ADC) 948. The gesture engine digital interface control logic block 946 provides a plurality of sensor outputs 950. These outputs, for example, can include a serial data and serial clock (e.g., for I²C communication). The infrared photometric sensor 920 also includes an LED driver 952 for driving an LED (e.g., sensor LED 918). The infrared photometric sensor 920 measures the intensity of reflected infrared light (e.g., from sensor LED 918) and can determine the angular orientation of the reflected infrared light within the field of view of the infrared photometric sensor 920. The infrared photometric sensor 920 provides for gesture sensing with less intensive data processing and filtering as compared with other gesture technologies (e.g., camera). Infrared photometric sensors 920, such as a photometric sensor for gesture and proximity detection enables ambient light rejection capability using analog filtering to improve operation of the infrared photometric sensor 920 in sunlight.

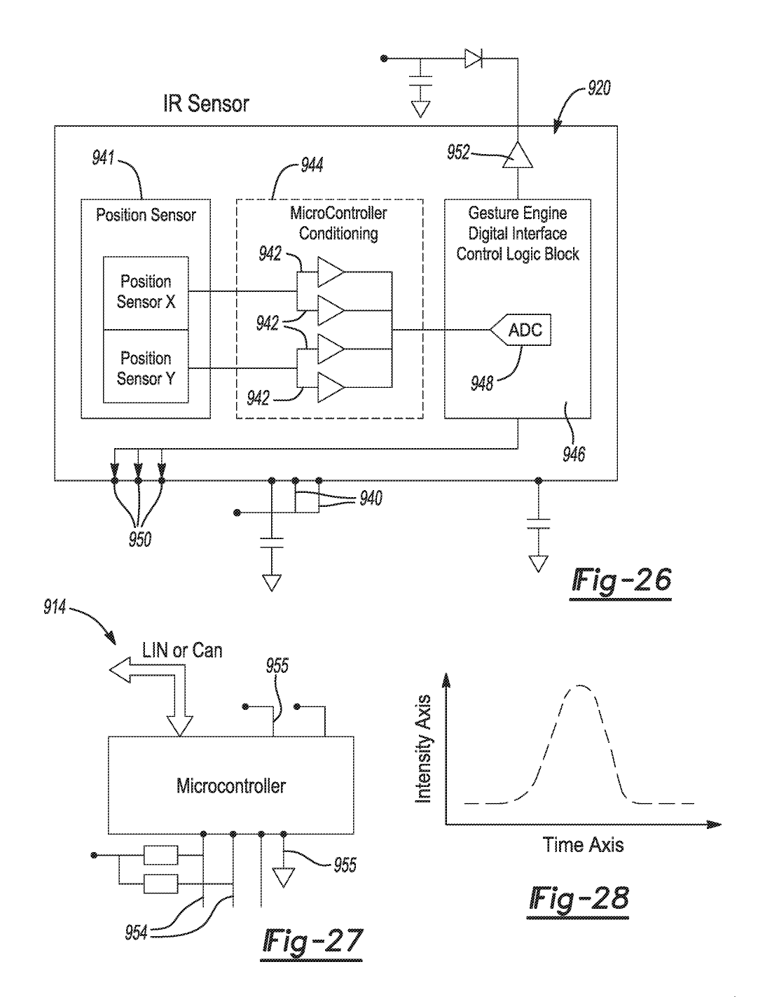

As best shown in FIG. 27, the sensor microcontroller 914 of the driver microcontroller and accent LED printed circuit board 910 includes a plurality of micro inputs 954 (e.g., serial data and serial clock to provide I²C communications with the infrared photometric sensor 920) and micro connections 955 (e.g., to power and ground). The sensor microcontroller 914 can be coupled to a LIN bus (e.g., LIN bus interface unit 110 shown in FIG. 2) or a CAN bus of vehicle 22 (e.g., CAN bus 28, shown in FIG. 2). The sensor microcontroller 914 receives data from the infrared photometric sensor 920 and process this IR sensor data and determine what gestures were used (i.e., recognition), send a signal to the vehicle 22 (e.g., main electronic control unit 24) to open the closure member (e.g., swing door 46), send a signal to the vehicle 22 to close the closure member, send motor control signals to the vehicle 22 to control the movement speed of the closure member (i.e., proximity mode for positioning feedback data).

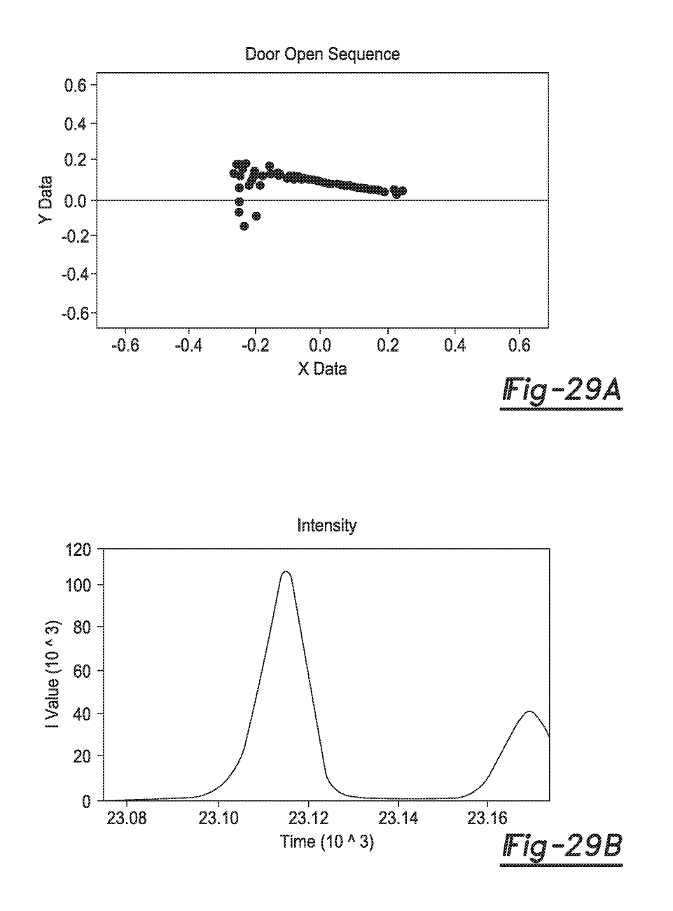

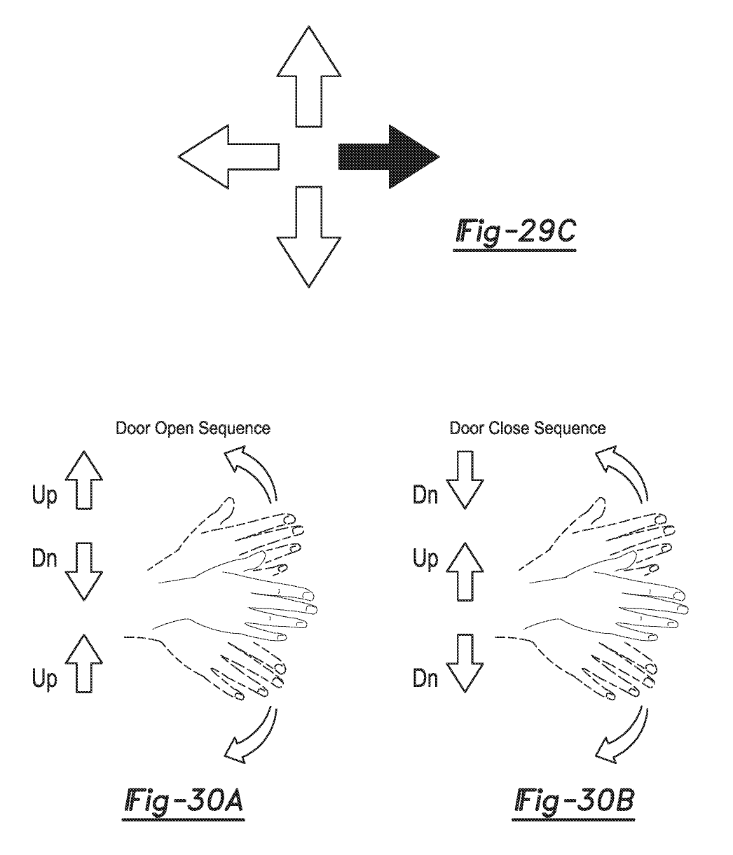

FIG. 28 illustrates a graph of a received intensity over time of a channel 942 of the infrared photometric sensor 920. The infrared photometric sensor 920 produces an intensity graph (i.e., position and intensity data received) for each of the four channels 942. These intensity graphs allow for the determination of gestures like left to right, right to left, top to bottom and bottom to top, for example. As best shown in FIGS. 29A and 29B, the received position and intensity data received from the infrared photometric sensor 920 can be used via a gesture algorithm (e.g., executed by the sensor microcontroller 914) to determine a swipe gesture (as shown in FIG. 29C). Example door close and door open gesture sequences are shown in FIGS. 30A and 30B, respectively. In more detail, a combination of individual swipes can be used to create a “gesture recognition sequence” to open or close a closure member (e.g., swing door 46). Consequently, a user can approach the vehicle 22 and swipe as shown in FIGS. 30A and 30B to either open or close the closure member. It should be appreciated that the virtual handle sensor could instead comprise sensors utilizing radar employing sensing techniques such as the Doppler Effect (i.e. detection of an object when it was moving) and ranging (i.e. measurement of distances to objects) (e.g. using Frequency Modulated Continuous Wave signal processing), as further described herein in more detail.

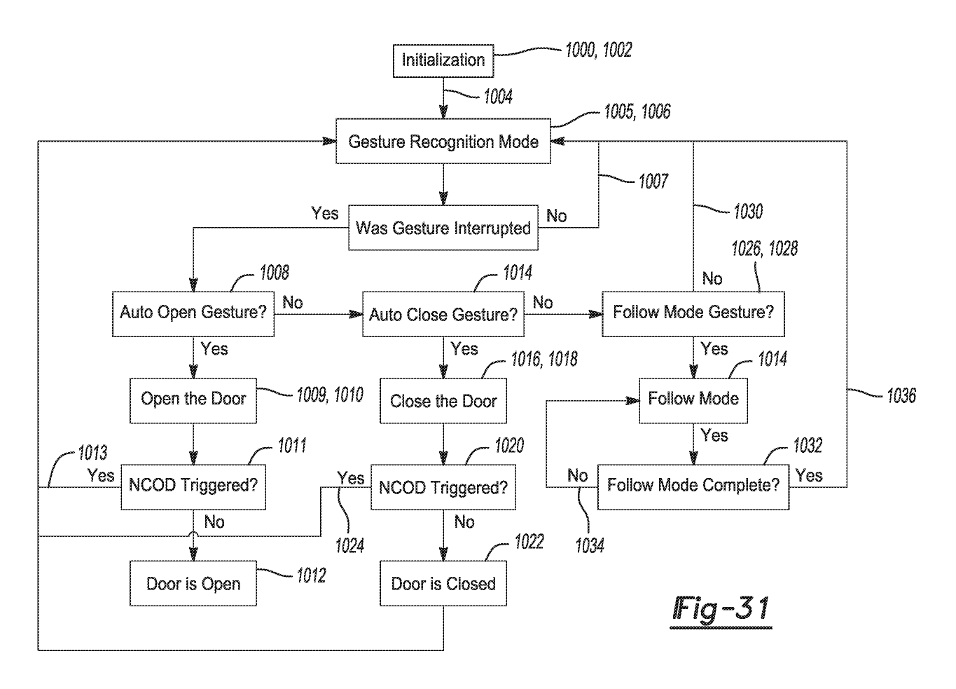

As illustrated in FIG. 31, a method of operating or moving a closure member (e.g., power swing door 46) using a virtual handle assembly 900 is disclosed. In accordance with an illustrative embodiment, the gesture recognition algorithm disclosed herein uses a straight line approximation, but other approximation techniques may be employed. The method includes the step of 1000 initializing a wait for lock/unlock state (e.g., until detecting a hand 901 and a key fob 760). Then, the method continues by 1002 remaining in the wait for lock/unlock state until an unlock signal is received (e.g., from the key fob 760). The method also includes the step of 1004 transitioning from the wait for lock/unlock state to a gesture recognition mode state in response to receiving the unlock signal.

While in the gesture recognition mode state, the virtual handle assembly 900 detects the position and gestures of the hand 901, so the method includes the step of 1005 determining the position of the hand 901 relative to the virtual handle assembly 900. The method proceeds with the step of 1006 determining whether the hand 901 is making a gesture in the gesture recognition mode state. The method continues by 1007 returning to the step of 1005 determining the position of the hand 901 relative to the virtual handle assembly 900 in response to determining that the hand 901 is not making a gesture. If at step 1006 it is determined that the hand 901 is making a gesture, then the next, step is 1008 determining if an auto open gesture is being made.

If the gesture is an auto open gesture, the method continues by moving the closure member, specifically, 1009 transitioning to a move member open state and opening the door in response to determining the hand 901 is making an auto open gesture and opening the closure member (e.g., moving the swing door 46 using the power door actuation system 720). Then, the method includes the steps of 1010 determining whether the closure member (e.g., power swing door 46) is open in the move member open state. Then, the method includes the step of 1011 determining whether the closure member moving triggers the NCOD (e.g. using the NCOD system 20 as described above). The method continues by 1012 transitioning to a member open state and back to the gesture recognition mode state in response to the closure member being open and in response to the NCOD not being triggered. The method also includes the step of 1013 transitioning back to the gesture recognition mode state in response to the NCOD being triggered (e.g., swing door 46 is stopped and is not being allowed to move until the obstacle has been cleared, or is no longer present).

The hand 901 may make other gestures, such as an auto close gesture. Thus, the method continues by 1014 determining if an auto close gesture is being made by the hand 901 and 1016 transitioning to a move member closed state and closing the closing member in response to determining the hand 901 making an auto close gesture (e.g., moving the swing door 46 using the power door actuation system 720). Then, the method includes the steps of 1018 determining whether the closure member (e.g., power swing door 46) is closed in the move member closed state. Then, the method includes the step of 1020 determining whether the closure member moving triggers the NCOD (e.g. detecting an object or obstacle using the NCOD system 20 as described above). The method continues by 1022 transitioning to a member open state and back to the gesture recognition mode state in response to the closure member being closed and in response to the NCOD not being triggered. The method also includes the step of 1024 transitioning back to the gesture recognition mode state in response to the NCOD being triggered (e.g., door 46 is stopped and is not being allowed to move until the obstacle has been cleared, or is no longer present).

In addition to the auto open and auto close gesture, the virtual handle assembly 900 can also detect a follow mode gesture, so the method includes the step of 1026 determining if a follow mode gesture is being made by the hand 901 and 1028 transitioning to a follow mode state and moving the closure member in response to determining the hand 901 is making a follow mode gesture (e.g., moving the swing door 46 using the power door actuation system 720). Then, the method includes the step of 1030 returning to the gesture recognition mode state in response to determining the hand 901 is not making a follow mode gesture. The method also includes the step of 1032 determining whether the follow mode gesture is complete. Then, the method includes the step of 1034 returning to the follow mode state in response to determining that the follow mode gesture is not complete. The method continues by 1036 returning to the gesture recognition mode state in response to determining that the follow mode is complete.

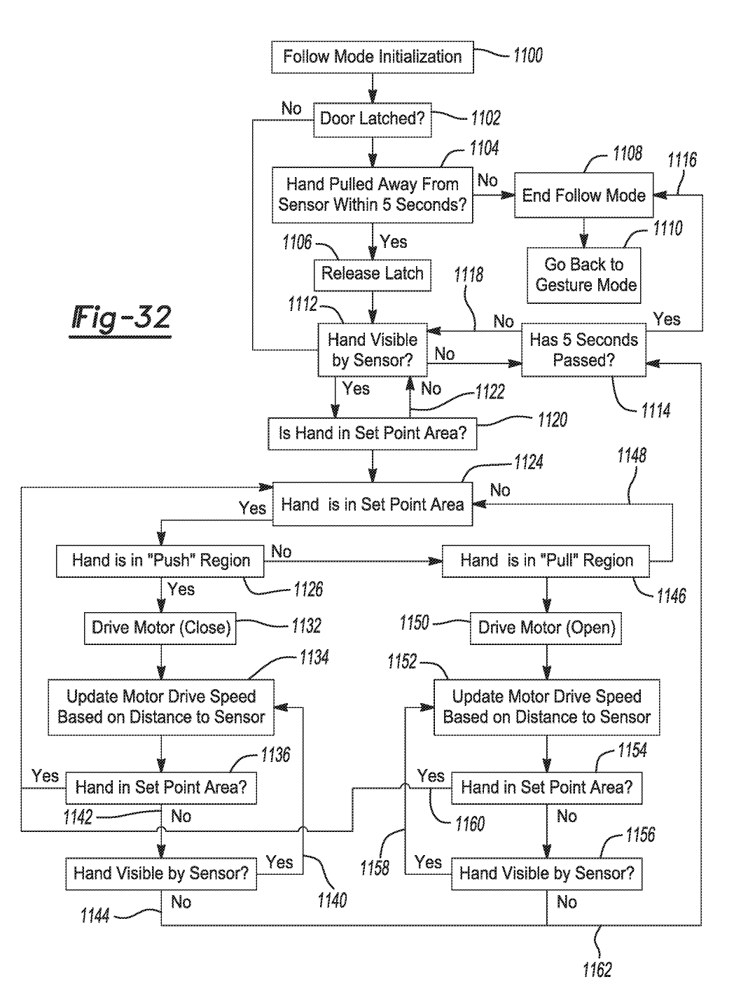

As discussed above, the method of operating or moving a closure member using a virtual handle assembly 900 includes the follow mode. FIG. 32 illustrates a method of operating the closure member in the follow mode using the virtual handle assembly 900. The method includes the step of 1100 initializing the follow mode in response to the virtual handle assembly 900 detecting a hand 901 (e.g., as well as a key fob 760). The method continues by 1102 determining whether a closure member is latched and 1104 determining whether the hand 901 has been pulled away from the virtual handle assembly 1100 in a predetermined amount of time (e.g., 5 seconds) in response to the door (e.g., power swing door 46) being latched. Then, the method continues by 1106 transitioning from a latched state to a release latch state and releasing a latch 801 in response to the hand 901 being pulled away from the virtual handle assembly 900. The method then includes the step of 1108 ending the follow mode in response to the hand 901 being pulled away from the virtual handle assembly 900. The method then continues by 1110 returning to the gesture mode in response to ending the follow mode.

However, if the closure member is not latched after initializing the follow mode, the method continues by 1112 determining whether the hand 901 is visible using the sensor (e.g., virtual handle sensor 902) in response to the closure member (e.g., power swing door 46) not being latched. The next step of the method is 1114 determining whether a predetermined amount of time has passed (e.g., 5 seconds) in response to the hand 901 not being visible using the sensor. Next, the method includes the step of 1616 ending the follow mode in response to the passing of the predetermined amount of time. The method also includes the step of 1118 returning the step of 1112 determining whether the hand 901 is visible using the sensor in response to the predetermined amount of time not passing. The method continues by 1120 determining if the hand 901 is in a set point area of the virtual handle assembly 900 in response to the hand 901 being visible using the sensor and 1122 returning to the step of 1112 determining whether the hand 901 is visible using the sensor in response to the hand 901 not being in the set point area. Then, the method proceeds with the step of 1124 transitioning to a set point state in response to the determination of the hand 901 being in the set point area.

While in the set point region or area, the hand 901can form various gestures, including a “push” gesture and so the method includes the step of 1126 determining in the set point state whether the hand 901 is moved to a push region relative to the virtual handle assembly 900. Next, 1132 transitioning to a drive motor close state in response to the determining that the hand 901 is in the push region relative to the virtual handle assembly 900. Then, the method includes the steps of 1134 monitoring a distance the hand 901 is from the virtual handle assembly 900 in the drive motor close state and continually updating a drive speed of a motor based on the distance the hand 901 is from the virtual handle assembly 900 so that the distance there between remains constant, e.g. the hand 901 is being followed by the door 712. The method continues with the step of 1136 determining whether the hand 901 is in the set point area and 1138 determining whether the hand 901 is visible by the sensor in response to the hand 901 not being in the set point area and 1140 returning to the step of 1134 monitoring a distance the hand 901 is from the virtual handle assembly 900 in the drive motor close state and continually updating a drive speed of a motor based on the distance the hand 901 is from the virtual handle assembly 900 in response to the hand 901 being visible by the sensor. The method proceeds by 1142 returning to the step of 1124 transitioning to the set point state in response to the hand 901 being in the set point area. The method also includes the step of 1144 returning to the step of 1114 determining whether a predetermined amount of time has passed (e.g., 5 seconds) in response to the hand 901 not being visible by the sensor.

Instead of making a “push” gesture, the hand 901 may make a “pull” gesture and so the method includes the step of 1146 determining whether the hand 901 is in a pull region in response to determining the hand 901 is not in a push region. The method continues by 1148 returning to the set point state in response to determining the hand 901 is not in a pull region. Next, 1150 transitioning to a drive motor open state in response to the determining that the hand 901 is in the pull region relative to the virtual handle assembly 900. Then, the method includes the steps of 1152 monitoring a distance the hand 901 is from the virtual handle assembly 900 in the drive motor open state and continually updating a drive speed of a motor based on the distance the hand 901 is from the virtual handle assembly 900. The method continues with the step of 1154 determining whether the hand 901 is in the set point area and 1156 determining whether the hand 901 is visible by the sensor in response to the hand 901 not being in the set point area and 1158 returning to the step of 1152 monitoring a distance the hand 901 is from the virtual handle assembly 900 in the drive motor open state and continually updating a drive speed of a motor based on the distance the hand 901 is from the virtual handle assembly 900 in response to the hand 901 being visible by the sensor. The method proceeds by 1160 returning to the step of 1124 transitioning to the set point state in response to the hand 901 being in the set point area. The method also includes the step of 1162 returning to the step of 1114 determining whether a predetermined amount of time has passed (e.g., 5 seconds) in response to the hand 901 not being visible by the sensor.

While the method and assembly have been illustratively described hereinabove with reference to detection of a hand gesture, other like types of objects making a gesture, such as a foot gesture, arm gesture, leg gesture, head gesture or other body part gesture, may be recognized.

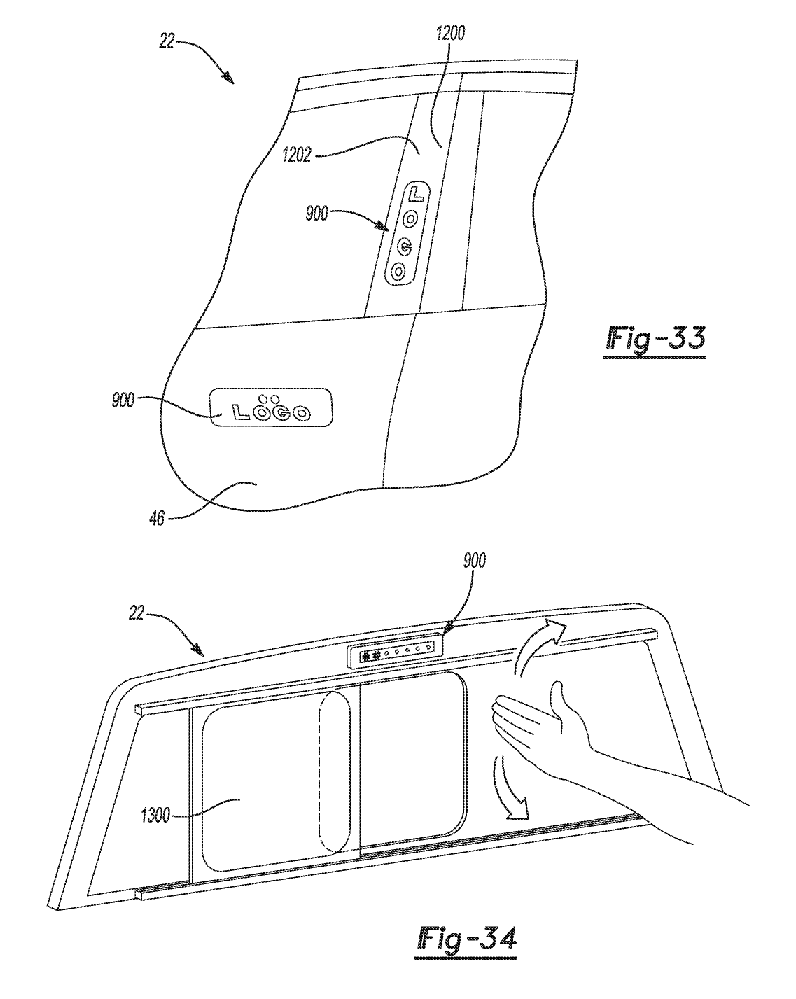

Clearly, changes may be made to what is described and illustrated herein without, however, departing from the scope defined in the accompanying claims. The non-contact obstacle detection system 20 or virtual handle assembly 900 may operate with myriad combinations of various types of non-contact sensors and for any closure members of the motor vehicle 22, for example. FIGS. 33 and 34 illustrate other possible embodiments of gesture recognition using a gesture assembly similar to virtual handle assembly 900. For instance, the virtual handle assembly 900 described above could be disposed in an applique 1200 or a B-pillar 1202 of the motor vehicle 22 for controlling the power swing door 46. Similarly, a gesture assembly similar to or the same as virtual handle assembly 900 could be installed above a rear power sliding window 1300 of the motor vehicle 22. In general, the non-contact obstacle detection system 20 or virtual handle assembly 900 may be used also for other purposes, within the motor vehicle 22, or for different automotive applications.

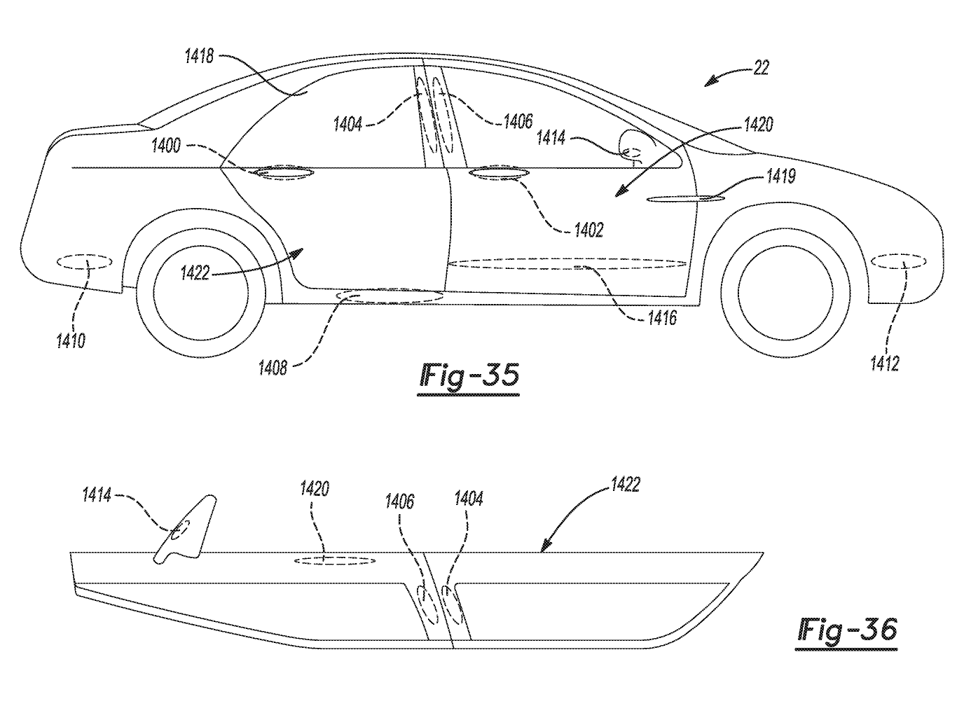

Now referring to FIGS. 35 to 46B, there are illustrated various exemplary positions and location of sensors of the non-contact obstacle detection system 20 for a motor vehicle 22. Such locations may include in the rear door handle 1400, the front door handle 1402, the rear door applique 1404, the front door applique 1406, the side rocker panel 1408, the rear bumper 1410, the front bumper 1412, the outside mirror 1414, and the inner door trim panel 1415, the door molding/trim 1416 as examples. Also, the sensors may be positioned behind a window 1418 or glass of the vehicle 22, such as the rear door window, or behind a vehicle accessory 1419 provided on a surface of the vehicle 22. FIG. 35 illustrates the positions of sensors for a side door non-contact obstacle detection system 20 which can provide sensor coverage for the front vehicle side door 1420 and the rear vehicle side door 1422.

Referring to FIG. 36, there is illustratively shown a field of view of the sensors providing a short distance horizontal sensor detection zone in the shape of an ellipse covering approximately 16 m² and a vertical sensor detection zone covering approximately 2 m above the ground (e.g. an ellipsoid).

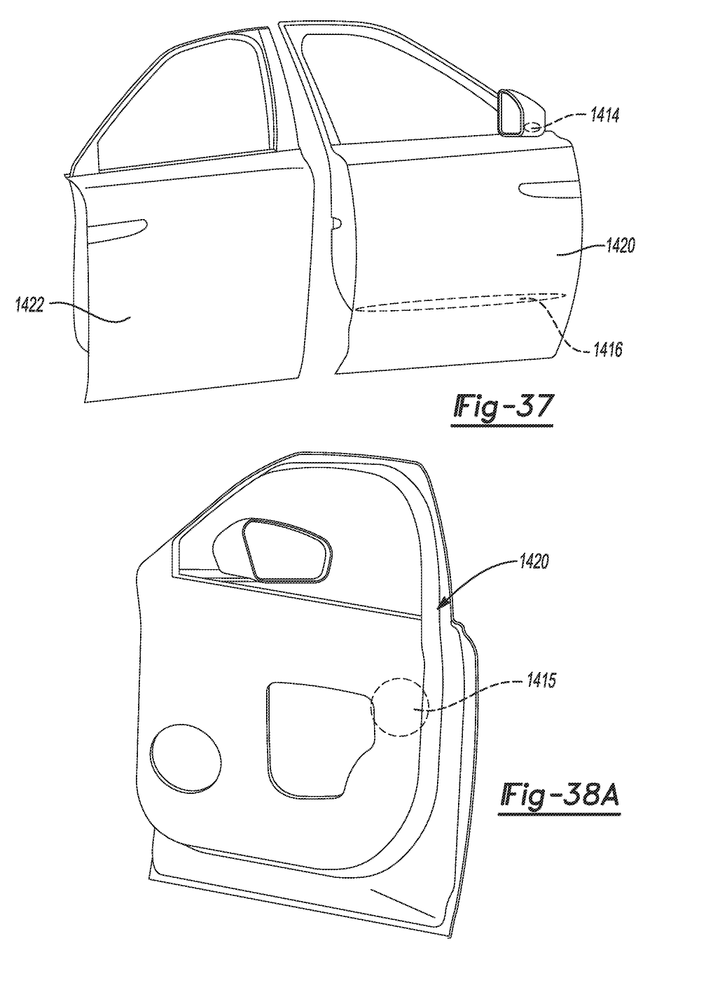

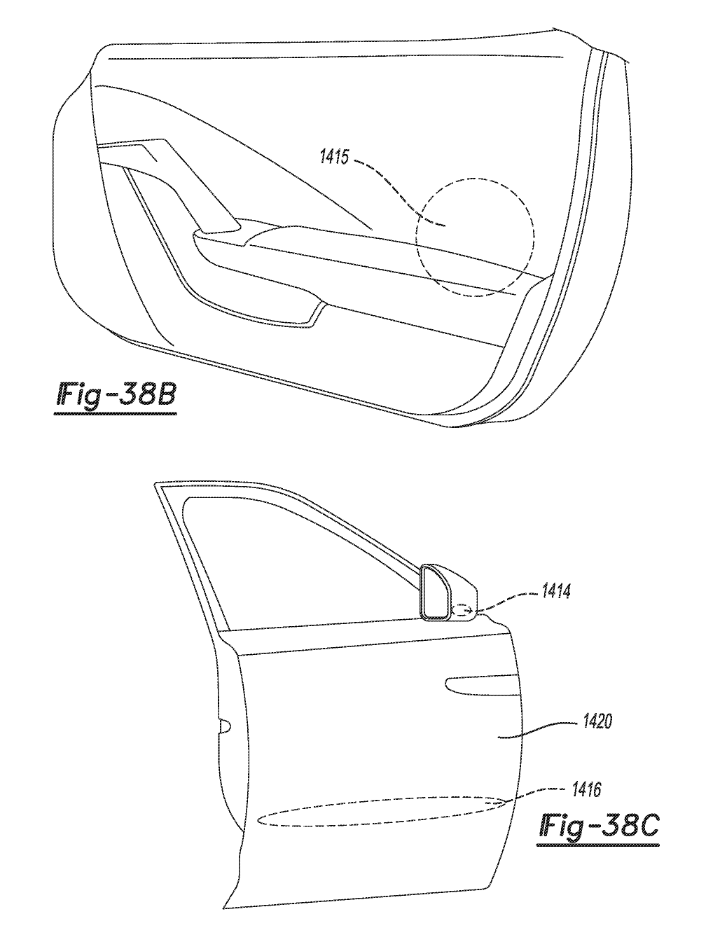

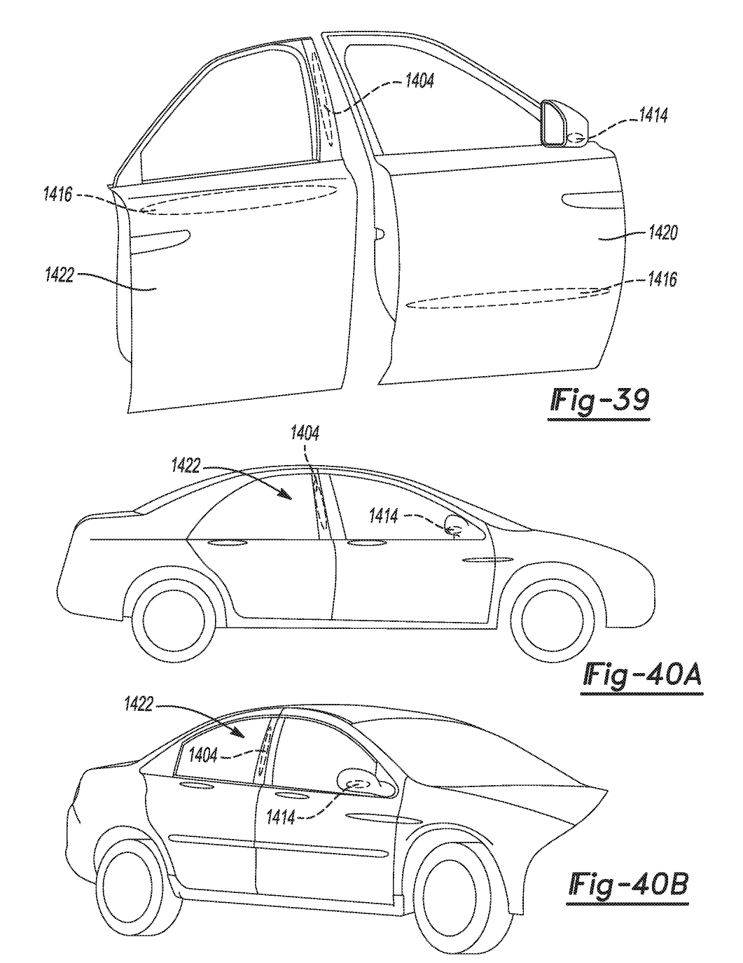

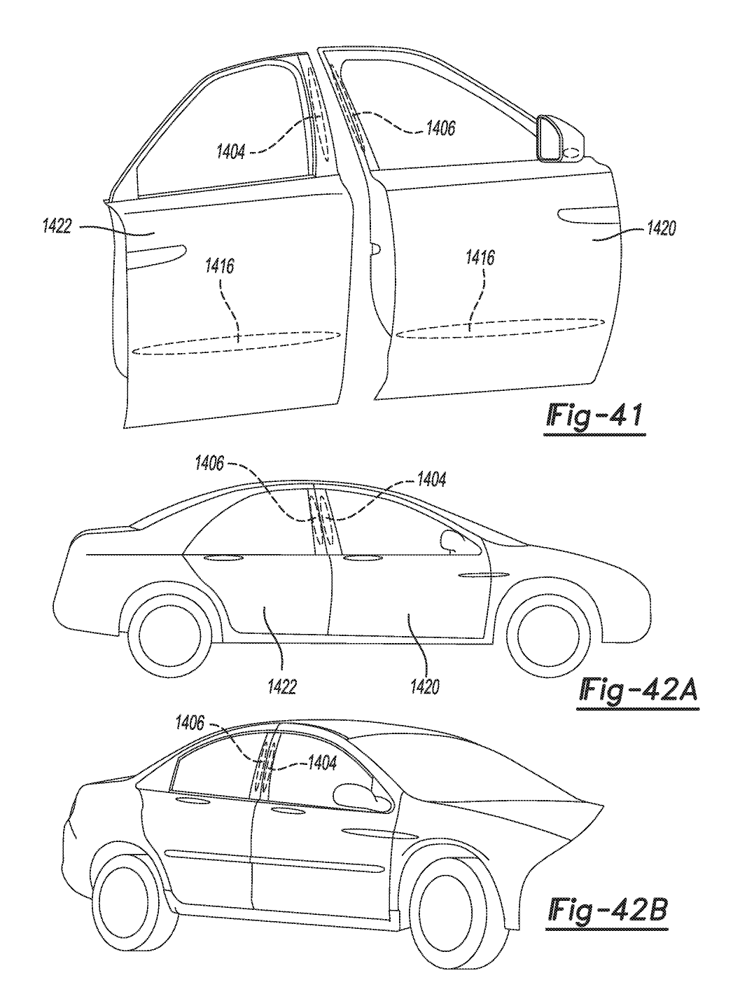

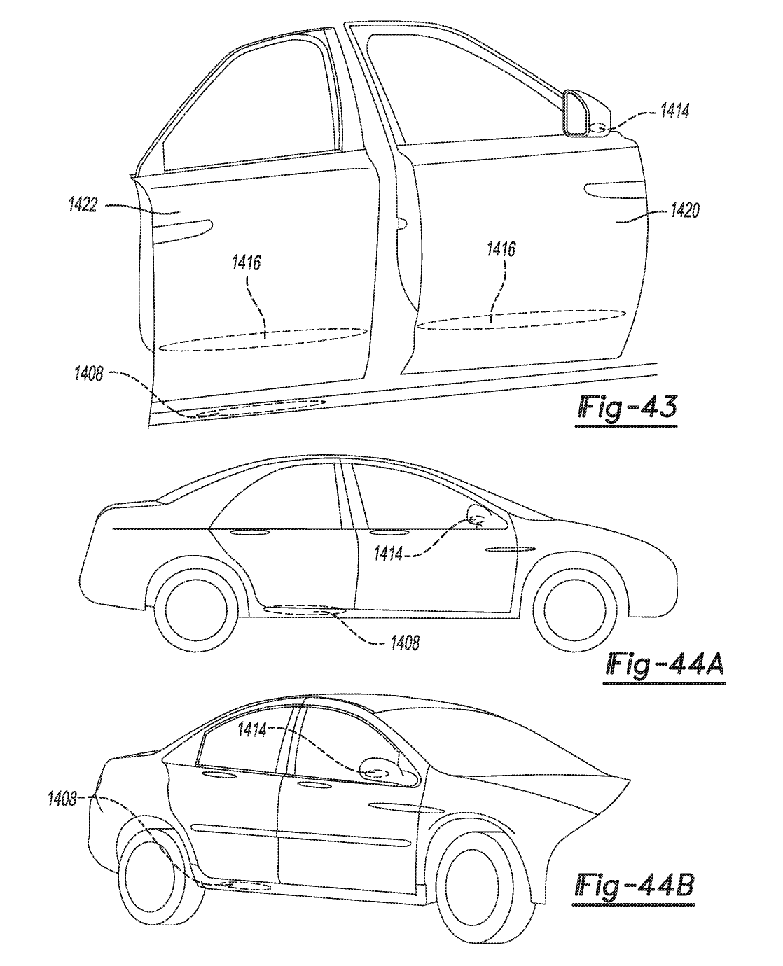

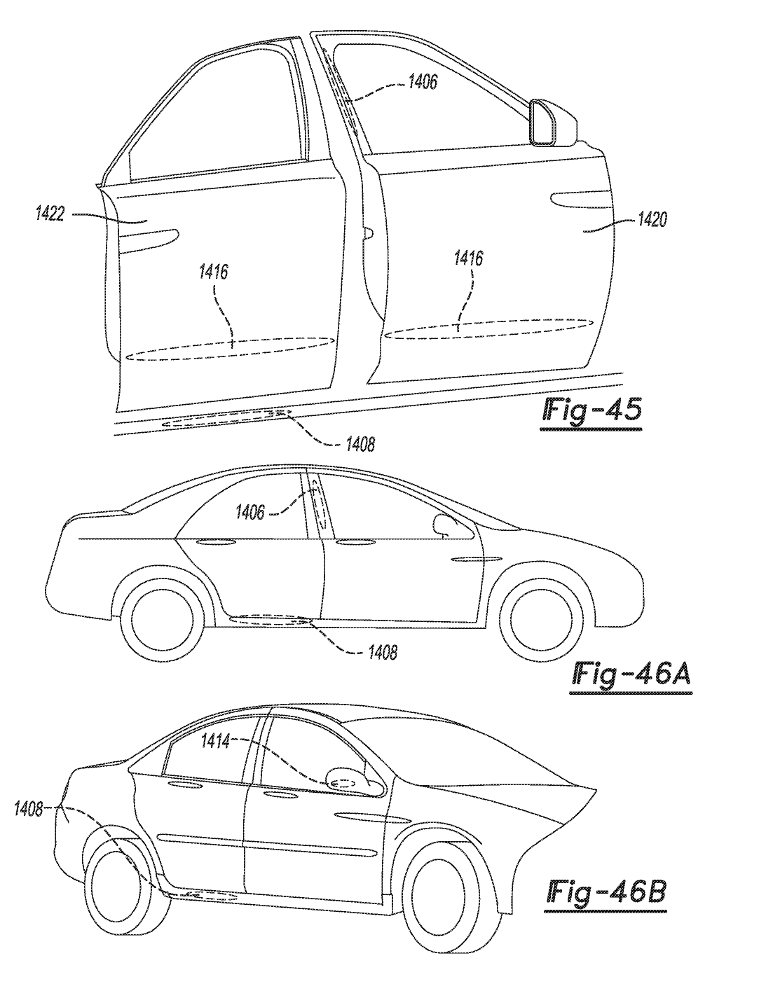

The non-contact obstacle detection system 20 may provide for singular locations of the sensors depending on the volume and area of coverage desired, but multiple sensors and combinations of sensors may be provided to cover a desired volume and area of detection for non-contact obstacle detection. Examples of combinations of sensors at different positions may include as example sensors positioned on the outside mirror 1414, inner door trim panel 1415, and door molding/trim 1416 (illustratively shown in FIG. 37 and FIGS. 38A-38C), the outside mirror and rear door applique 1404 (illustratively shown in FIG. 39 and FIGS. 40A-40B), the front door applique 1406 and the rear door applique 1404 (illustratively shown in FIG. 41 and FIGS. 42A-42B), the outside mirror 1414 and the side rocker panel 1408 (FIG. 43 and FIGS. 44A-44B), the front door applique 1406 and the side rocker panel 1408. Other combinations of sensor locations are possible.

Now referring to FIG. 37 and FIGS. 38A-38C, there is illustratively shown sensors positioned on the outside mirror 1414, inner door trim panel 1415, and door molding/trim 1416. This configuration of sensors allows the non-contact obstacle detection system 20 to operate in different states or modes during the movement of the front vehicle door 1420, 1422. For example, the sensor provided at the outside mirror 1414 location operates as a primary sensor location to monitor/detect objects in the zone in front of both the front vehicle side door 1420 and the rear vehicle side door 1422. In the event only the front vehicle side door 1420 is open, since the sensor located at the outside mirror 1414 will move along with the movement of the front vehicle side door 1420, the field of view of the sensor located at the outside mirror 1414 will change and the area/volume of coverage in front rear vehicle side door 1422 will be reduced as the front vehicle side door 1420 is opened. To compensate for this reduction in detection coverage, the sensor located at the inner door trim panel 1415 on the front vehicle side door 1420 (secondary sensor location) may be activated and transitioned to a detection mode to provide detection of the zone in front of the rear vehicle side door 1422 when the front vehicle side door 1420 is open. Thus if the rear vehicle side door 1422 is opened, the sensor located at the inner door trim panel 1415 of the front vehicle side door 1420 may provide the obstacle detection coverage for obstacles in front of the rear vehicle side door 1422. When the front vehicle side door 1420 is returned to its closed position, the sensor located at the inner door trim panel 1415 of the front vehicle side door 1420 may be transitioned to a mode where it is inactive since the sensor located at the outside mirror 1414 will be positioned again to be able to provide detection coverage in front of the rear vehicle side door 1422.

Now referring to FIG. 39 and FIGS. 40A-40B, there is illustratively shown sensors positioned on the outside mirror 1414 and rear door applique 1404. This configuration of sensors allows the non-contact obstacle detection system 20 to operate in different states or modes during the movement of the front vehicle door 1420, 1422. For example, the sensor provided at the outside mirror 1414 location operates as a primary sensor location to monitor/detect objects in the zone in front of both the front vehicle side door 1420 and the rear vehicle side door 1422. In the event only the front vehicle side door 1420 is open, since the sensor located at the outside mirror 1414 will move along with the movement of the front vehicle side door 1420, the field of view of the sensor located at the outside mirror 1414 will change and the area/volume of coverage in front rear vehicle side door 1422 will be reduced as the front vehicle side door 1420 is opened. To compensate for this reduction in detection coverage, the sensor located at the rear door applique 1404 (secondary sensor location) may be activated and transitioned to a detection mode to provide detection of the zone in front of the rear vehicle side door 1422 when the front vehicle side door 1420 is open. Thus if the rear vehicle side door 1422 is opened, the sensor located at the rear door applique 1404 may provide the obstacle detection coverage for obstacles in front of the rear vehicle side door 1422. When the front vehicle side door 1420 is returned to its closed position, the sensor located at the rear door applique 1404 may be transitioned to a mode where it is inactive since the sensor located at the outside mirror 1414 will be positioned again to be able to provide detection coverage in front of the rear vehicle side door 1422.

Now referring to FIG. 41 and FIGS. 42A-42B, there is illustratively shown sensors positioned on the front door applique 1406 and rear door applique 1404. This configuration of sensors allows the non-contact obstacle detection system 20 to operate in different states or modes during the movement of the front vehicle side door 1420, 1422. For example, the sensor provided at the front door applique 1406 location operates as a primary sensor location to monitor/detect monitors the zone in front of both the front vehicle side door 1420 and the rear vehicle side door 1422. In the event only the front vehicle side door 1420 is open, since the sensor located at the front door applique 1406 will move along with the movement of the front vehicle side door 1420, the field of view of the sensor located at the front door applique 1406 will change and the area/volume of coverage in front rear vehicle side door 1422 will be reduced as the front vehicle side door 1420 is opened. To compensate for this reduction in detection coverage, the sensor located at the rear door applique 1404 (secondary sensor location) may be activated and transitioned to a detection mode to provide detection of the zone in front of the rear vehicle side door 1422 when the front vehicle side door 1420 is open. Thus is the rear vehicle side door 1422 is opened, the sensor located at the rear door applique 1404 may provide the obstacle detection coverage for obstacles in front of the rear vehicle side door 1422. When the front vehicle side door 1420 is returned to its closed position, the sensor located at the rear door applique 1404 may be transitioned to a mode where it is inactive since the sensor located at the front door applique 1406 will be positioned again to be able to provide detection coverage in front of the rear vehicle side door 1422.

Now referring to FIG. 43 and FIGS. 44A-44B, there is illustratively shown sensors positioned on the outside mirror 1414 and rear side rocker panel 1408. This configuration of sensors allows the non-contact obstacle detection system 20 to operate in different states or modes during the movement of the front vehicle door 1420, 1422. For example, the sensor provided at the outside mirror 1414 location operates as a primary sensor location to monitor/detect monitors the zone in front of both the front vehicle side door 1420 and the rear vehicle side door 1422. In the event only the front vehicle side door 1420 is open, since the sensor located at the outside mirror 1414 will move along with the movement of the front vehicle side door 1420, the field of view of the sensor located at the outside mirror 1414 will change and the area/volume of coverage in front rear vehicle side door 1422 will be reduced as the front vehicle side door 1420 is opened. To compensate for this reduction in detection coverage, the sensor located at the rear side rocker panel 1408 (secondary sensor location) may be activated and transitioned to a detection mode to provide detection of the zone in front of the rear vehicle side door 1422 when the front vehicle side door 1420 is open. Thus is the rear vehicle side door 1422 is opened, the sensor located at the rear side rocker panel 1408 may provide the obstacle detection coverage for obstacles in front of the rear vehicle side door 1422. When the front vehicle side door 1420 is returned to its closed position, the sensor located at the rear side rocker panel 1408 may be transitioned to a mode where it is inactive since the sensor located at the outside mirror 1414 will be positioned again to be able to provide detection coverage in front of the rear vehicle side door 1422.

Now referring to FIG. 45 and FIGS. 46A-46B, there is illustratively shown sensors positioned on the front door applique 1406 and rear side rocker panel 1408. This configuration of sensors allows the non-contact obstacle detection system 20 to operate in different states or modes during the movement of the front vehicle door 1420, 1422. For example, the sensor provided at the front door applique 1406 location operates as a primary sensor location to monitor/detect monitors the zone in front of both the front vehicle side door 1420 and the rear vehicle side door 1422. In the event only the front vehicle side door 1420 is open, since the sensor located at the front door applique 1406 will move along with the movement of the front vehicle side door 1420, the field of view of the sensor located at the front door applique 1406 will change and the area/volume of coverage in front rear vehicle side door 1422 will be reduced as the front vehicle side door 1420 is opened. To compensate for this reduction in detection coverage, the sensor located at the rear side rocker panel 1408 (secondary sensor location) may be activated and transitioned to a detection mode to provide detection of the zone in front of the rear vehicle side door 1422 when the front vehicle side door 1420 is open. Thus if the rear vehicle side door 1422 is opened, the sensor located at the rear side rocker panel 1408 may provide the obstacle detection coverage for obstacles in front of the rear vehicle side door 1422. When the front vehicle side door 1420 is returned to its closed position, the sensor located at the rear side rocker panel 1408 may be transitioned to a mode where it is inactive since the sensor located at the front door applique 1406 will be positioned again to be able to provide detection coverage in front of the rear vehicle side door 1422.

While illustrative examples of primary and secondary sensor locations are shown which operate in different detection modes depending on the movement of the front vehicle side door 1420, other configurations may be provided, including primary, secondary, tertiary, quaternary, and quinary, and so forth, depending on the number of sensors provided as part of the obstacle detection system 20, which may operate mutually exclusively, or simultaneously. For example, the sensor located at the rear bumper 1410 may be transitioned to a detection mode when the front vehicle side door 1420 is opened. For example, the sensor in the front door handle 1402 the sensor at the front door applique 1406 may be transitioned to an inactive mode when the rear vehicle side door 1422 is opened since the sensor at the rear door handle 1400 or in the rear door applique 1404 may provide for sensing detection of the zone in front of the vehicle front side door 1420 as the rear vehicle door 1422 is opened.

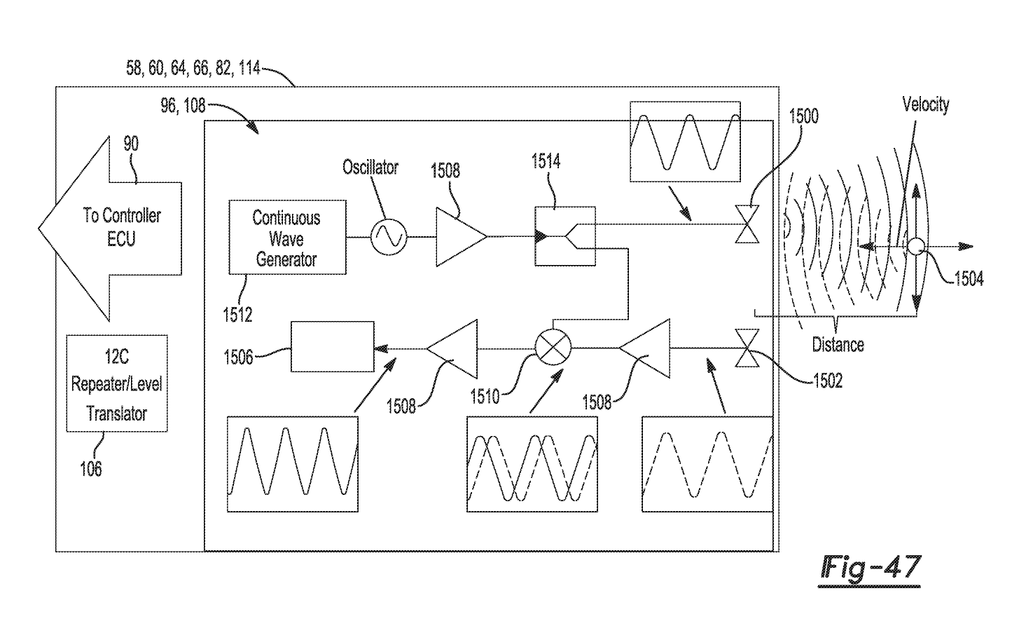

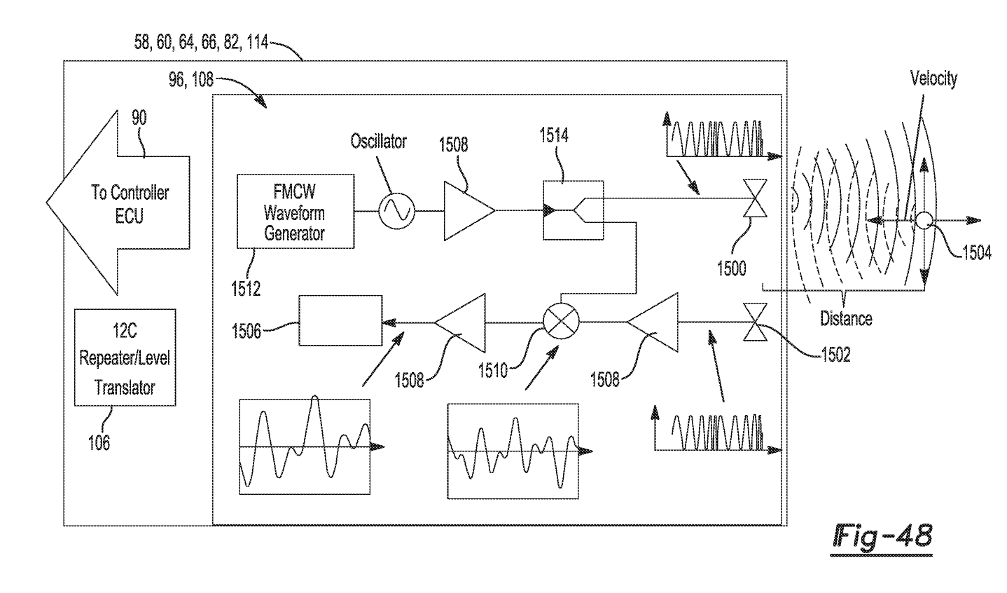

The sensor modules 58, 60, 64, 66, 82, 114 may be configured to transmit and detect radio waves as part of a radar based obstacle and gesture detection system. With reference to FIGS. 47 to 49, the sensor modules 58, 60, 64, 66, 82, 114 can be configured to emit continuously modulated radiation, ultra-wideband radiation, or sub-millimeter-frequency radiation (e.g., frequencies forming part of the ISM frequency band about 24GHz, or the 60GHz frequency band as examples, but other ranges are also contemplated). For example, the sensor modules 58, 60, 64, 66, 82, 114 may be configured to emit continuously emitted radiation by the radar emitting element 1500, such as an antenna, or continuous wave (CW) radar, known in the art to use Doppler radar techniques, which can be employed in the radar based obstacle or gesture recognition sensor as illustrated in FIG. 47. A modulated emitted radiation by the radar emitting element 1500, or frequency modulated continuous wave (FMCW) radar, also known in the art to use Doppler radar techniques, may also be employed in the radar based gesture recognition and obstacle detection sensor as illustrated in FIG. 48. Also, the sensor may be configured for pulsed time-of-flight radar. The sensor modules 58, 60, 64, 66, 82, 114 includes one or more receive elements 1502, such as antenna(s), for receiving the reflections of the transmitted radar waves, which reflect off of an object or a user 1504. The radar emitting element 1500 may be integrated into the sensor printed circuit board 124, or integrated into a radar chip affixed to the sensor printed circuit board 124.

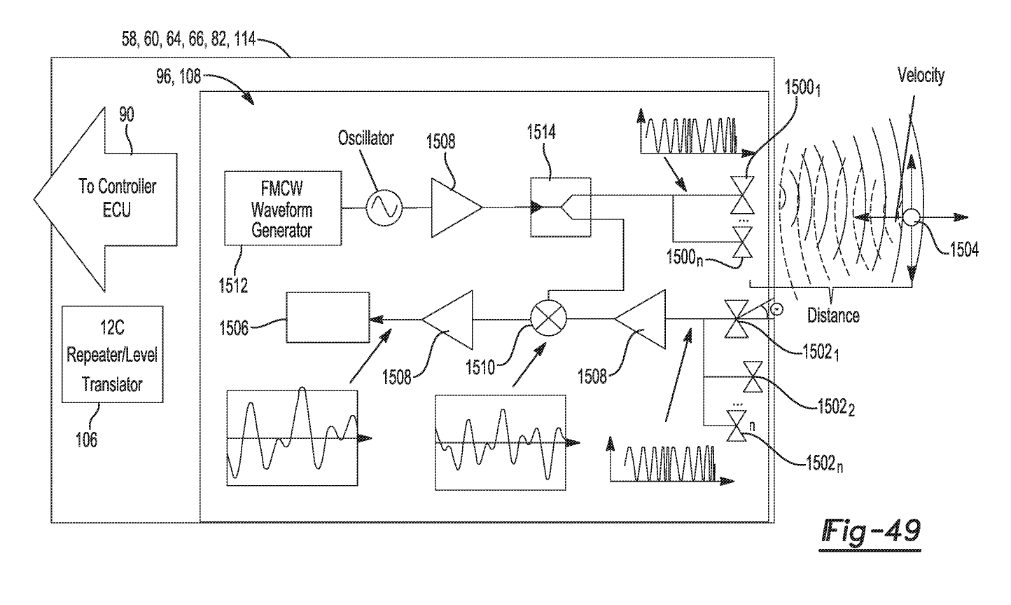

The sensor modules 58, 60, 64, 66, 82, 114 may be configured to emit and detect continuous wave (CW) radar, as is illustratively shown in FIG. 48 with the radar based gesture recognition and obstacle detection sensor including one transmit antenna 1500 and one receive antenna 1502. With such a configuration, the radar based gesture recognition and obstacle detection sensor is operable to detect a speed/velocity of the object/user 1504 using the Doppler Radar principles (i.e. processing by the main electronic control unit 24 or a dedicated local application specific radar signal processor 1506 of the received reflected CW radar signal to determine frequency shifts of an emitted continuous radiation wave indicative of the speed of the object or user 1504). The radar emitting element 1500 can be also configured to emit frequency modulated continuous wave (FMCW) radar, as is illustratively shown in FIG. 48, with the radar based gesture recognition system including one transmit antenna 1500 and one receive antenna 1502. With such a configuration, the radar based gesture recognition and obstacle detection system is operable to detect a gesture/motion of the obstacle/user 1504 using the Frequency Modulated Radar techniques (i.e. processing by a signal processor 1506 or main electronic control unit 24 of the reflected FMCW radar signal to determine frequency shifts indicative of the speed (Doppler frequency) and distance (beat frequency) of the object/user 1504). Alternatively the FMWC radar system can be configured to include at least two receive antennas 15021, 15022, to 1502n forming an antenna array, as shown in FIG. 49. Also, multiple transmit antennas 1500n may be provided. The signal processor 1506 is illustrated disposed in communication with the antenna element(s) 1502 through signal processing elements such as high/low gain signal amplifiers 1508, a mixer 1510 configured to mix the received signal with the transmitted signal generated by a waveform generator 1512 as received from a splitter 1514 for processing the received reflections (i.e. the signal processor 1506 or main electronic control unit 24 can be configured execute instructions stored in a memory to perform calculations on the received reflection and transmitted radiation signals (i.e. mixed signals) to implement the various detection techniques or algorithms e.g. CW Radar, FMCW Radar, time of flight) within the intermediate radar field to provide gesture data for determining the gesture made by the user. For example, the signal processor 1506 or main electronic control unit 24 can be configured to process the received reflection to determine a Doppler shift for calculating the speed/velocity of the object or user 1504, or a frequency shift for calculating the distance and speed of the object or user 1504.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Those skilled in the art will recognize that concepts disclosed in association with an example system can likewise be implemented into many other systems to control one or more operations and/or functions.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments. Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

What is claimed is:

1. A virtual handle assembly comprising:
a handle housing;
at least one virtual handle sensor disposed in said handle housing for detecting a hand in proximity to the virtual handle assembly;
a sensor microcontroller disposed in said handle housing and coupled to said at least one virtual handle sensor and in communication with an actuation system coupled to a closure member and configured to:
detect one of a gesture and a hand being placed in proximity the at least one virtual handle sensor, and
command movement of the closure member by the actuation system in response to the detection one of a gesture and a hand being placed in proximity to said at least one virtual handle sensor.

2. The virtual handle assembly as set forth in claim 1, further including a driver microcontroller and accent LED printed circuit board disposed within a compartment of said handle housing and including a plurality of multi-color LEDs and said sensor microcontroller disposed thereon.

3. The virtual handle assembly as set forth in claim 2, further including a handle infrared sensor printed circuit board electrically coupled to said driver microcontroller and accent LED printed circuit board including a sensor LED and said at least one virtual handle sensor disposed thereon.

4. The virtual handle assembly as set forth in claim 3, wherein said at least one virtual handle sensor includes an infrared photometric sensor in communication with said sensor microcontroller via I²C communications.

5. The virtual handle assembly as set forth in claim 3, further including a cover plate extending over said driver microcontroller and accent LED printed circuit board and said handle infrared sensor printed circuit board and defining a plurality of graphic openings for allowing light from said plurality of multi-color LEDs to pass through said cover plate and said cover plate additionally defining sensor openings each aligned with said sensor LED and said at least one virtual handle sensor.

6. The virtual handle assembly as set forth in claim 1, wherein said gesture is an auto close gesture and said sensor microcontroller is additionally configured to command closure of the closure member by the actuation system in response to the detection of the auto close gesture.

7. The virtual handle assembly as set forth in claim 1, wherein said gesture is an auto open gesture and said sensor microcontroller is additionally configured to command opening of the closure member by the actuation system in response to the detection of the auto open gesture.

8. The virtual handle assembly as set forth in claim 1, wherein said sensor microcontroller is coupled to an NCOD system and additionally configured to determine whether the NCOD system is triggered during movement of the closure member.

9. A method of moving a closure member using a virtual handle assembly comprising the steps of:
determining a position of a hand relative to the virtual handle assembly;
determining whether the hand is making a gesture in a gesture recognition mode state;
moving the closure member in response to determining that the hand is making a gesture;
determining whether the closure member moving triggers a NCOD system; and
transitioning back to the gesture recognition mode state in response to the NCOD system being triggered.

10. The method as set forth in claim 9, further including the steps of:
initializing a wait for lock/unlock state;
remaining in the wait for lock/unlock state until an unlock signal is received;
transitioning from the wait for lock/unlock state to the gesture recognition mode state in response to receiving the unlock signal; and
returning to the step of determining the position of the hand relative to the virtual handle assembly in response to determining that the hand is not making a gesture.

11. The method as set forth in claim 9, further including the steps of:
determining if an auto open gesture is being made;
transitioning from the gesture recognition mode state to a move member open state in response to determining that the hand is making an auto open gesture;
determining whether the closure member is open in the move member open state; and
transitioning to a member open state and back to the gesture recognition mode state in response to the closure member being open and in response to the NCOD system not being triggered.

12. The method as set forth in claim 9, further including the steps of:
determining if an auto close gesture is being made by the hand;
transitioning to a move closure member closed state and closing the closure member in response to determining the hand making an auto close gesture;
determining whether the closure member is closed in the move member closed state; and
transitioning to a member closed state and back to the gesture recognition mode state in response to the closure member being closed and in response to the NCOD system not being triggered.

13. The method as set forth in claim 9, further including the steps of:
determining if a follow mode gesture is being made by the hand;
transitioning to a follow mode state and moving the closure member in response to determining the hand is making a follow mode gesture; and
returning to the gesture recognition mode state in response to determining the hand is not making a follow mode gesture.

14. The method as set forth in claim 13, further including the steps of:
determining whether the follow mode gesture is complete;
returning to the follow mode state in response to determining that the follow mode is not complete; and
returning to the gesture recognition mode state in response to determining that the follow mode is complete.

15. The method as set forth in claim 13, further including the steps of:
initializing the follow mode in response to the virtual handle assembly detecting the hand;
determining whether the hand has been pulled away from the virtual handle assembly;
ending the follow mode in response to the hand being pulled away from the virtual handle assembly;
determining whether the hand is visible using a sensor of the virtual handle assembly;
determining if the hand is in a set point area of the virtual handle assembly in response to the hand being visible using the sensor;
returning to the step of determining whether the hand is visible using the sensor in response to the hand not being in the set point area;
transitioning to a set point state in response to the determination of the hand being in the set point area;
determining in the set point state whether the hand is moved to a push region relative to the virtual handle assembly;
transitioning to a drive motor close state in response to the determining that the hand is in the push region relative to the virtual handle assembly;
monitoring a distance the hand is from the virtual handle assembly in the drive motor close state and continually updating a drive speed of a motor based on the distance the hand is from the virtual handle assembly;
determining whether the hand is in a pull region in response to determining the hand is not in a push region;
transitioning to a drive motor open state in response to the determining that the hand is in the pull region relative to the virtual handle assembly; and
monitoring a distance the hand is from the virtual handle assembly in the drive motor open state and continually updating a drive speed of the motor based on the distance the hand is from the virtual handle assembly.

16. The method as set forth in claim 15, further including the steps of:
determining whether the closure member is latched; and
transitioning from a latched state to a release latch state and releasing a latch in response to the hand being pulled away from the virtual handle assembly.

17. The method as set forth in claim 15, further including the steps of:
determining whether a predetermined amount of time has passed in response to the hand not being visible using a sensor of the virtual handle assembly;
ending the follow mode in response to the passing of the predetermined amount of time; and
returning the step of determining whether the hand is visible using the sensor in response to the predetermined amount of time not passing.

18. The method as set forth in claim 17, further including the steps of:
returning to the step of determining whether a predetermined amount of time has passed in response to the hand not being visible by the sensor; and
returning to the set point state in response to determining the hand is not in a pull region.

19. The method as set forth in claim 15, further including the steps of:
determining whether the hand is visible by the sensor in response to the hand not being in the set point area;
returning to the step of monitoring the distance the hand is from the virtual handle assembly in the drive motor close state and continually updating a drive speed of a motor based on the distance the hand is from the virtual handle assembly in response to the hand being visible by the sensor; and
returning to the step of transitioning to the set point state in response to the hand being in the set point area.

20. The method as set forth in claim 15, further including the steps of:
determining whether the hand is visible by the sensor in response to the hand not being in the set point area;
returning to the step of monitoring a distance the hand is from the virtual handle assembly in the drive motor open state and continually updating a drive speed of a motor based on the distance the hand is from the virtual handle assembly in response to the hand being visible by the sensor;
returning to the step of transitioning to the set point state in response to the hand being in the set point area; and
returning to the step of determining whether a predetermined amount of time has passed in response to the hand not being visible by the sensor.

21. A non-contact obstacle detection system for controlling movement of at least one closure member of a vehicle having an outside portion and an inside portion opposite the outside portion and movable between a closed position and an open position, comprising:
a plurality of non-contact obstacle sensors each having a detection zone about at least one closure member and configured to be in one of an active mode and an inactive mode in response to the position of the at least one closure member for detecting obstacles near the at least one closure member;
a main electronic control unit adapted to connect to a power source and having a plurality of input-output terminals and coupled to said plurality of non-contact obstacle sensors and configured to:
determine movement of the at least one closure member between the closed position and the open position,
selectively switch each of the plurality of non-contact obstacle sensors between the active mode and the inactive mode based on the movement of the at least one closure member,
detect if the obstacles are detected using the plurality of non-contact obstacle sensors, and
cease movement of the at least one closure member and disable the system in response to the obstacles being detected.

22. The non-contact obstacle detection system as set forth in claim 21, wherein said plurality of non-contact obstacle sensors includes at least one non-contact obstacle sensor disposed on the outside portion of the at least one closure member and at least one non-contact obstacle sensor disposed on the inner portion of the at least one closure member and said main electronic control unit is further configured to switch the at least one non-contact obstacle sensor disposed on the outside portion of the at least one closure member to the inactive mode and switch the at least one non-contact obstacle sensor disposed on the inside portion of the at least one closure member the active mode in response to movement of the at least one closure member from the closed position to the open position.

23. The non-contact obstacle detection system as set forth in claim 21, wherein said plurality of non-contact obstacle sensors includes at least one non-contact obstacle sensor disposed on the at least one closure member and at least one non-contact obstacle sensor disposed remotely from the at least one closure member and said main electronic control unit is further configured to switch the at least one non-contact obstacle sensor disposed on the at least one closure member to the inactive mode and switch the at least one non-contact obstacle sensor disposed remotely from the at least one closure member to the active mode in response to movement of the at least one closure member.

24. The non-contact obstacle detection system as set forth in claim 21, wherein said plurality of non-contact obstacle sensors are disposed in positions of the vehicle selected from a group consisting of: a trim panel on the outside portion of the at least one closure member, behind a trim panel on the inside portion of the at least one closure member, a handle of the least one closure member, a window of the at least one closure member, an applique of the at least one closure member, and a bumper of the vehicle.
